(19) United States
(12) Patent Application Publication
(10) Pub. No.: US 2019/0213660 A1
(43) Pub. Date: Jul. 11, 2019

(54) SYSTEMS AND METHODS FOR PROVIDING USER-SPECIFIC RESULTS BASED ON TEST-DRIVE OF PRODUCT OR SERVICE

(71) Applicant: Wallupt, Inc., Chevy Chase, MD (US)

(72) Inventors: Sebastian Astrada, Chevy Chase, MD (US); Carlos Astrada, Gaithersburg, MD (US)

(21) Appl. No.: 16/304,335

(22) PCT Filed: May 24, 2017
(86) PCT No.: PCT/US17/34169

§ 371 Date: Nov. 26, 2018

Related U.S. Application Data
(60) Provisional application No. 62/340,705, filed on May 24, 2016.

(51) Int. Cl. G06Q 30/06; G06Q 40/02

(52) U.S. Cl. CPC G06Q 30/0631; G06Q 40/02

(57) ABSTRACT

Disclosed herein are systems and methods to test-drive a product or service and provide user-specific results that includes a look-back period, a forward projection, or both.

### CROSS REFERENCE TO RELATED APPLICATIONS

This application claims priority to U.S. Provisional Patent Application No. 62/340,705 filed on May 24, 2016, the contents of which are hereby incorporated by reference in their entirety.

### TECHNICAL FIELD

The present disclosure relates generally to the technical field of electronic commerce and computer technology, and in particular, to systems and methods to test-drive a product or service and provide user-specific results that includes a look-back period, a forward projection, or both.

### BACKGROUND

Mobile devices are becoming more and more resourceful, and provide various functionalities or mobile applications to make everyday tasks simpler and more efficient. One area where mobile devices are being used is the mobile commerce environment. For example, mobile devices have been augmented to include mobile applications that can be used to match consumers to products and services, by educating consumers on the features of the products and services and enabling the consumer to assess the fitness for use of the products and services.

Existing mobile applications, websites, and web browsers provide consumers with information such as product and service data, ratings, reviews, rankings, recommendations, and quotes, with respect to consumer and small business financial products. For example, Mint, a website and mobile application, provides personal financial management software (PFM) with product recommendations based on user data and advertising agreements. NerdWallet is a browser based finders tool to connect consumers to financial education information and financial products based on user selected preferences. Credit Karma and Credit Sesame are browser and mobile application credit monitoring tools with recommendation engines based on details in the consumer's credit profile, such as an interest rate comparison. Existing mobile applications, websites, and browsers, however, are limited to providing brokering services for financial products and services based on search tools and recommendations based on very limited consumer data and analysis. The various computer platforms and associated computer networks operating in these contexts typically rely upon (a) simple match analysis to provide consumers with suggestions for products or services based on a single or few data points (as in the case of users with a certain amount of assets being offered investment account products or services); (b) the consumer furnishing data on its feature preferences in a particular segment, like credit cards, to enable the service to show consumers only those products and services that match the user-defined feature set; or (c) consumer data obtained through the capture of data on the consumer's credit report, which enables the service to provide credit related offers for products and services to the consumer, most often through a simple match analysis as described above or a simple comparison of a single feature, such as APR. In particular, existing mobile applications are limited by their data sets, their data architecture, as well as their business strategies and lack the capability in employing certain technical algorithms to intelligently match consumers to products and services that have any impact on a consumer's finances. As a result, existing finder's platforms are limited in their abilities to match consumers to products and services due to reliance on basic filtering mechanisms. In addition, no service provides consumers with the ability to understand the precise impact of a product or service on the consumer's particular facts, circumstances, and needs and interests. Instead, consumers must engage in the information gathering and analysis that the consumer believes is appropriate to ascertain the impact or fitness for purpose of the product or service.

There remains a need for personalized decision tools for consumers that are specific to a consumer's facts, circumstances, needs and interests, and enable the consumer to obtain the products and services that are optimal for the consumer.

### SUMMARY OF THE INVENTION

The presently disclosed subject matter provides a system to test-drive a product or service and provide user-specific results via a test-drive interactive component comprising a mobile computing device comprising at least one storage device; and at least one processor communicatively coupled to the at least one storage device. The at least one processor executes instructions that are stored in the at least one storage device to cause the mobile computing device to perform the following steps:

in a test-drive subsystem of the mobile computing device: receive user data from a mobile application server and store user data; receive product data from at least one institution system and store the product data, wherein such product data relates to a product or service;
by a user interface of the mobile computing device: receive user selection of at least one of a product type or a service type;
in a test-drive interactive component of the mobile computing device: apply product-suggestion business rules to user data; determine at least one suggested product or service based on the applied product-suggestion business rules; present a test drive interface for suggested product(s) or service(s); receive user selection of one of the suggested product(s) or service(s) for test drive; apply test-drive business rules to user data for application in the selected test drive interface; and provide user-specific results comprising a financial assessment that includes a look-back period, a forward projection, or both.

The presently disclosed subject matter provides a non-transitory computer-readable storage medium having stored thereon computer executable instructions to cause a mobile computing device to test-drive a product or service and provide user-specific results via a test-drive interactive component, wherein the computer executable instructions comprises: computer-executable program instructions to receive user data; computer-executable program instructions to receive product data, wherein such product data relates to a product or service; computer-executable program instructions to receive user selection of at least one of a product type or a service type; computer-executable program instructions to apply product-suggestion business rules to user data; computer-executable program instructions to determine at least one suggested product or service based on the applied product-suggestion business rules; computer-executable program instructions to present a test drive interface for each suggested product(s) or service(s); computer-executable program instructions to receive user selection of one of the suggested product(s) or service(s) for test drive; computer-executable program instructions to apply test-drive business rules to user data for application in the selected test drive interface; and computer-executable program instructions to provide user-specific results comprising a financial assessment that includes a look-back period, a forward projection, or both.

The presently disclosed subject matter provides a method to test-drive a product or service and provide user-specific results via a test-drive interactive component, comprising: at a mobile computing device comprising a processor and memory: receiving and storing, in a test-drive subsystem of the mobile computing device, user data; receiving and storing, in the test-drive subsystem of the mobile computing device, product data from a provider, wherein such product data relates to a product or service; receiving, by a user interface of the mobile computing device, user selection of at least one of a product type, or a service type; applying, by a product suggestion manager of the mobile computing device, product-suggestion business rules to user data; determining, by the product suggestion manager of the mobile computing device, at least one suggested product or service based on the applied product-suggestion business rules; presenting, by the user interface of the mobile computing device, a test drive interface for the suggested product(s) or service(s); receiving, by the user interface of the mobile computing device, user selection of at least one of the suggested product(s) or service(s) for test drive; applying, by a product fit manager of the mobile computing device, test-drive business rules to user data for application in the test drive interface for the user selected product(s) or service(s); and providing, by a product fit manager of the mobile computing device, user-specific results comprising an assessment that includes a look-back period, a forward projection, or both a look-back period and a forward projection.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a schematic diagram of a system for providing user-specific results comprising a financial assessment that includes a look-back period, a forward projection, or both according to embodiments of the present disclosure;

FIG. 2 is a schematic diagram of backend architecture of a system for providing user-specific results comprising a financial assessment that includes a look-back period, a forward projection, or both according to embodiments of the present disclosure;

FIG. 3 is a flow chart of an exemplary method for providing user-specific results comprising a financial assessment that includes a look-back period, a forward projection, or both according to embodiments of the present disclosure;

FIG. 4 is a flow chart of an exemplary method for referring a user to selected product or service, and allocating a referral fee to mobile application provider according to embodiments of the present disclosure;

FIG. 5 is a flow chart of an exemplary method for referring a user to selected product or service, and allocating a rewards benefit to user according to embodiments of the present disclosure;

FIG. 6 is a flow chart of an exemplary method for providing financial action plan data that adds steps to the flow chart depicted in FIG. 3, according to embodiments of the present disclosure;

FIGS. 7A and 7B are front views of an exemplary mobile device including a touch screen display for displaying prompts to receive user data and suggested products according to embodiments of the present disclosure;

FIG. 8A are front views of an exemplary mobile device including a touch screen display for displaying prompts for receive selection of a financial action plan and displaying financial action plan data according to embodiments of the present disclosure; FIG. 8B are front views of an exemplary mobile device including a touch screen display for providing user-specific results comprising a financial assessment that includes a look-back period, a forward projection, or both; and

FIG. 9 are front views of an exemplary mobile device including a touch screen display for displaying suggested products and prompts to receive user selection of a product or service for test drive, and providing user-specific results comprising a financial assessment that includes a look-back period, a forward projection, or both.

FIG. 10 is an example plot of the Elbow method for defining the number of clusters

FIG. 11 is an example plot of the clusters as calculated above using K-means clustering

### DETAILED DESCRIPTION OF REPRESENTATIVE EMBODIMENTS

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements Like numbers refer to elements throughout. Where possible, any terms expressed in the singular form herein are meant to also include the plural form and vice versa, unless explicitly stated otherwise.

The representative embodiments disclosed herein address a need for personalized decision tools for consumers and improvements to the technical field of electronic commerce and computer technology, such as new systems and methods comprising novel algorithms, are needed to enable consumers to test-drive a product or service and receive quantitative and qualitative user-specific results regarding use of a product or service, thereby enabling the consumer to select and obtain the products and services that are optimal for the consumer's personal circumstances and well-being. The disclosures herein provide prediction and clustering algorithms to assess consumer and product data related to a product or service, display suggested products or services to the consumer, and enable the consumer to test drive the suggested products and services. The novel systems and methods employ numerical computations (not replicable by hand in analog) and regression analysis to predict values, and regression analysis and multiclass classification algorithms as well as clustering algorithms to predict categories, in each case in order to demonstrate to the consumer whether and how the consumer's historical financial behaviors and outcomes would be affected as if the consumer had been using the product or service.

The presently disclosed subject matter provides a system to test-drive a product or service and provide user-specific results via a test-drive interactive component comprising a mobile computing device comprising at least one storage device; and at least one processor communicatively coupled to the at least one storage device. The at least one processor executes instructions that are stored in the at least one storage device to cause the mobile computing device to perform the following steps:

in a test-drive subsystem of the mobile computing device: receive user data from a mobile application server and store user data; receive product data from at least one institution system and store the product data, wherein such product data relates to a product or service;
by a user interface of the mobile computing device: receive user selection of at least one of a product type or a service type;
in a test-drive interactive component of the mobile computing device: apply product-suggestion business rules to user data; determine at least one suggested product or service based on the applied product-suggestion business rules; present a test drive interface for suggested product(s) or service(s); receive user selection of one of the suggested product(s) or service(s) for test drive; apply test-drive business rules to user data for application in the selected test drive interface; and provide user-specific results comprising a financial assessment that includes a look-back period, a forward projection, or both.

The presently disclosed subject matter provides a non-transitory computer-readable storage medium having stored thereon computer executable instructions to cause a mobile computing device to test-drive a product or service and provide user-specific results via a test-drive interactive component, wherein the computer executable instructions comprises: computer-executable program instructions to receive user data; computer-executable program instructions to receive product data, wherein such product data relates to a product or service; computer-executable program instructions to receive user selection of at least one of a product type or a service type; computer-executable program instructions to apply product-suggestion business rules to user data; computer-executable program instructions to determine at least one suggested product or service based on the applied product-suggestion business rules; computer-executable program instructions to present a test drive interface for each suggested product(s) or service(s); computer-executable program instructions to receive user selection of one of the suggested product(s) or service(s) for test drive; computer-executable program instructions to apply test-drive business rules to user data for application in the selected test drive interface; and computer-executable program instructions to provide user-specific results comprising a financial assessment that includes a look-back period, a forward projection, or both.

The presently disclosed subject matter provides a method to test-drive a product or service and provide user-specific results via a test-drive interactive component, comprising: at a mobile computing device comprising a processor and memory: receiving and storing, in a test-drive subsystem of the mobile computing device, user data; receiving and storing, in the test-drive subsystem of the mobile computing device, product data from a provider, wherein such product data relates to a product or service; receiving, by a user interface of the mobile computing device, user selection of at least one of a product type, or a service type; applying, by a product suggestion manager of the mobile computing device, product-suggestion business rules to user data; determining, by the product suggestion manager of the mobile computing device, at least one suggested product or service based on the applied product-suggestion business rules; presenting, by the user interface of the mobile computing device, a test drive interface for the suggested product(s) or service(s); receiving, by the user interface of the mobile computing device, user selection of at least one of the suggested product(s) or service(s) for test drive; applying, by a product fit manager of the mobile computing device, test-drive business rules to user data for application in the test drive interface for the user selected product(s) or service(s); and providing, by a product fit manager of the mobile computing device, user-specific results comprising an assessment that includes a look-back period, a forward projection, or both a look-back period and a forward projection.

In some embodiments, the product data from a provider is data based on a user's use of a product or service. In some embodiments, presenting a test drive interface for the suggested product(s) or service(s) comprises presenting a test drive interface for a combination of suggested product(s), a combination of suggested service(s) or a combination of suggested product(s) and suggested service(s). In some embodiments, receiving user selection of at least one of the suggested product(s) or service(s) comprises receiving user selection of a combination of suggested product(s), a combination of suggested service(s) or a combination of suggested product(s) and suggested service(s). In some embodiments, the product fit manager of the mobile computing device comprises computer-executable program instructions to employ numerical computations, regression analysis, multi-class classification algorithms, or clustering algorithms.

In some embodiments, the assessment is a financial assessment that includes a look-back period comprising data regarding whether and how user historical financial behaviors or outcomes would be affected as if the user had been using the user selected product(s) or service(s); wherein applying, by a product fit manager of the mobile computing device, test-drive business rules to user data for application in the test drive interface comprises: calculating absolute and relative changes in expenses across historical timeframes; and wherein providing, by a product fit manager of the mobile computing device, user-specific results comprises: displaying absolute and relative changes in expenses across historical timeframes.

In some embodiments, the assessment is a financial assessment that includes a look-back period comprising data regarding whether and how user historical financial behaviors or outcomes would be affected as if the user had been using the user selected product(s) or service(s); wherein applying, by a product fit manager of the mobile computing device, test-drive business rules to user data for application in the test drive interface comprises: calculating absolute and relative changes in income across historical timeframes; and wherein providing, by a product fit manager of the mobile computing device, user-specific results comprises: displaying absolute and relative changes in income across historical timeframes.

In some embodiments, the assessment is a financial assessment that includes a look-back period comprising data regarding whether and how user historical financial behaviors or outcomes would be affected as if the user had been using the user selected product(s) or service(s); wherein applying, by a product fit manager of the mobile computing device, test-drive business rules to user data for application in the test drive interface comprises: calculating absolute and relative changes in debt across historical timeframes; and wherein providing, by a product fit manager of the mobile computing device, user-specific results comprises: displaying absolute and relative changes in debt across historical timeframes.

In some embodiments, the assessment is a financial assessment that includes a look-back period comprising data regarding whether and how user historical financial behaviors or outcomes would be affected as if the user had been using the user selected product(s) or service(s); wherein applying, by a product fit manager of the mobile computing device, test-drive business rules to user data for application in the test drive interface comprises: calculating absolute and relative changes in assets across historical timeframes; and wherein providing, by a product fit manager of the mobile computing device, user-specific results comprises: displaying absolute and relative changes in assets across historical timeframes.

In some embodiments, the assessment is a financial assessment that includes a look-back period comprising data regarding whether and how user historical financial behaviors or outcomes would be affected as if the user had been using the user selected product(s) or service(s); wherein applying, by a product fit manager of the mobile computing device, test-drive business rules to user data for application in the test drive interface comprises: calculating absolute and relative changes in net wealth across historical timeframes; and wherein providing, by a product fit manager of the mobile computing device, user-specific results comprises: displaying absolute and relative changes in net wealth across historical timeframes. In some embodiments, the historical timeframes are 1 month, 3 months, 6 months, and 1 year, and multiples of 1 year.

In some embodiments, the assessment is a financial assessment that includes a look-back period comprising data regarding whether and how user historical behaviors and practices would be consistent with good usage of the user selected product(s) or service(s) or would result in issues in using the user selected product(s) or service(s);

wherein applying, by a product fit manager of the mobile computing device, test-drive business rules to user data for application in the test drive interface comprises: determining historical months in which the user would have faced difficulty or failure in meeting expenses if the user were using the user selected product(s) or service(s), wherein the computer-executable program instructions of the product fit manager comprises computer-executable program instructions to employ numerical computations to: calculate a mean variation of user's expenses to income ratio, determine a difficulty month wherein the user selected product(s) or service(s) increases expenses or decreases income in any month by an amount in excess of the mean variation, and, determine a failure month wherein the user selected product(s) or service(s) increases expenses or decreases income in any month to such an extent that the user's expenses are greater than income; and
wherein providing, by a product fit manager of the mobile computing device, user-specific results comprises: displaying historical months in which the user would have faced difficulty or failure in meeting expenses if the user were using the user selected product(s) or service(s).

In some embodiments, the assessment is a financial assessment that includes a look-back period comprising data regarding whether and how user historical behaviors and practices would be consistent with good usage of the user selected product(s) or service(s) or would result in issues in using the user selected product(s) or service(s);

wherein applying, by a product fit manager of the mobile computing device, test-drive business rules to user data for application in the test drive interface comprises: determining frequency of difficulty month(s) or failure month(s) compared to a user historical time series, wherein the computer-executable program instructions of the product fit manager comprises computer-executable program instructions to employ numerical computations to: calculate aggregate data on the frequency of difficulty month(s) or failure month(s) compared to the user historical time series to demonstrate severity on a proportional basis; and
wherein providing, by a product fit manager of the mobile computing device, user-specific results comprises: displaying frequency of difficulty month(s) or failure month(s) compared to a user historical time series.

In some embodiments the assessment is a financial assessment that includes a look-back period comprising data regarding whether and how user historical behaviors and practices would be consistent with good usage of the user selected product(s) or service(s) or would result in issues in using the user selected product(s) or service(s);

wherein applying, by a product fit manager of the mobile computing device, test-drive business rules to user data for application in the test drive interface comprises: determining user historical behaviors that support or detract from successful use of the user selected product(s) or service(s), wherein the computer-executable program instructions of the product fit manager comprises computer-executable program instructions to employ clustering algorithms to: define classes or clusters of users that the user belongs to, find characteristics in the class that are statistically significant in predicting success or failure in using the user selected product(s) or service(s), and identify whether the user has the characteristics; and
wherein providing, by a product fit manager of the mobile computing device, user-specific results comprises: displaying user historical behaviors that support or detract from successful use of the user selected product(s) or service(s).

In some embodiments, the clustering algorithms to predict categories comprises Bayesian parameter averaging or multinomial logistic regression. In some embodiments, the user historical time series is 1, 3, 6, 9, 12, 24, 36, 48, and 72 months.

In some embodiments, the assessment is a financial assessment that includes a forward projection comprising data regarding whether and how the user can expect to be impacted by using the user selected product(s) or service(s) and the extent to which using the product would impact the user's cash management preferences, budget goals, or other financial action plans;

wherein applying, by a product fit manager of the mobile computing device, test-drive business rules to user data for application in the test drive interface comprises: the user's absolute and relative changes in expenses, income, debt, assets, and net worth across a forward-looking timeframe; and
wherein providing, by a product fit manager of the mobile computing device, user-specific results comprises: displaying the user's absolute and relative changes in expenses across forward looking timeframes.

In some embodiments, the assessment is a financial assessment that includes a forward projection comprising data regarding whether and how the user can expect to be impacted by using the user selected product(s) or service(s) and the extent to which using the product would impact the user's cash management preferences, budget goals, or other financial action plans;

wherein applying, by a product fit manager of the mobile computing device, test-drive business rules to user data for application in the test drive interface comprises: predicting the user's absolute and relative changes to compliance with the user's cash management or budgeting preferences and other financial action plans; and
wherein providing, by a product fit manager of the mobile computing device, user-specific results comprises: displaying the user's absolute and relative changes to compliance with the user's cash management or budgeting preferences and other financial action plans.

In some embodiments, the assessment is a financial assessment that includes a forward projection comprising data regarding whether and how the user can expect to be impacted by using the user selected product(s) or service(s) and the extent to which using the product would impact the user's cash management preferences, budget goals, or other financial action plans;

wherein applying, by a product fit manager of the mobile computing device, test-drive business rules to user data for application in the test drive interface comprises: predicting the user's absolute and relative changes in meeting the user's cash management or budgeting preferences; and
wherein providing, by a product fit manager of the mobile computing device, user-specific results comprises: displaying the user's absolute and relative changes in meeting the user's cash management or budgeting preferences.

In some embodiments, the assessment is a financial assessment that includes a forward projection comprising data regarding whether and how the user can expect to be impacted by using the user selected product(s) or service(s) and the extent to which using the product would impact the user's cash management preferences, budget goals, or other financial action plans;

wherein applying, by a product fit manager of the mobile computing device, test-drive business rules to user data for application in the test drive interface comprises: predicting the absolute and relative changes in the user's ability to complete other financial action plans or comply with other user preferences; and
wherein providing, by a product fit manager of the mobile computing device, user-specific results comprises: displaying the absolute and relative changes in the user's ability to complete other financial action plans or comply with other user preferences.

In some embodiments, the assessment is a financial assessment that includes a forward projection comprising data regarding whether the user is likely to succeed in using the selected product(s) or service(s) based on a behavioral assessment of user in relation to the selected product(s) or service(s) characteristics and other user experience with the selected product(s) or service(s);

wherein applying, by a product fit manager of the mobile computing device, test-drive business rules to user data for application in the test drive interface comprises: assessing the user's financial wellness, wherein the computer-executable program instructions of the product fit manager comprises computer-executable program instructions to: perform a weighted assessment of the user's debt to income ratio, income to expenses ratio, average monthly variation in income, average monthly variation in expenses, average monthly variation in income to expenses ratio, credit score, changes to credit score over past year, credit use to credit availability ratio, savings rate, and presence of 3 or 6 months of emergency savings; reassessing the user's financial wellness assuming use of the selected product(s) or service(s), wherein the computer-executable program instructions of the product fit manager comprises computer-executable program instructions to: employ numerical computations to calculate the user's financial wellness and determine the absolute and relative changes to user's financial wellness from using the selected product(s) or service(s); and
wherein providing, by a product fit manager of the mobile computing device, user-specific results comprises: providing a numerical score for user financial wellness.

In some embodiments, the assessment is a financial assessment that includes a forward projection comprising data regarding whether the user is likely to succeed in using the selected product(s) or service(s) based on a behavioral assessment of user in relation to the selected product(s) or service(s) characteristics and other user experience with the selected product(s) or service(s);

wherein applying, by a product fit manager of the mobile computing device, test-drive business rules to user data for application in the test drive interface comprises: predicting the user's ability to successfully use the selected product(s) or service(s), wherein the computer-executable program instructions of the product fit manager comprises computer-executable program instructions to: determine characteristics that are statistically significant in success or failure in using the selected product(s) or service(s); and determining whether the user has any of the statistically significant characteristics, and calculating user likelihood of success, wherein the computer-executable program instructions of the product fit manager comprises computer-executable program instructions to: perform a match analysis based on a weighted analysis of the user's matched characteristics; and
wherein providing, by a product fit manager of the mobile computing device, user-specific results comprises: displaying absolute and relative changes to user's financial wellness from using the selected product(s) or service(s); and displaying user likelihood of success in using the selected product(s) or service(s).

In some embodiments, the assessment is a financial assessment that includes a forward projection comprising data regarding whether and how any alternatives to the selected product(s) or service(s) would improve outcomes for the user relative to the test-driven product(s) or service(s);

wherein applying, by a product fit manager of the mobile computing device, test-drive business rules to user data for application in the test drive interface comprises: identifying alternative product(s) or service(s) from the product-suggestion manager, and assessing a percentage difference in satisfaction between the test-driven product(s) or service(s) and an alternative product(s) or service(s) among users in the same user segment or cohort; and
wherein providing, by a product fit manager of the mobile computing device, user-specific results comprises: displaying the percentage difference in satisfaction between the test-driven product(s) or service(s) and an alternative product(s) or service(s) among users in the same user segment or cohort.

In some embodiments, the assessment is a financial assessment that includes a forward projection comprising data regarding whether and how any alternatives to the selected product(s) or service(s) that would improve outcomes for the user relative to the test driven product(s) or service(s);

wherein applying, by a product fit manager of the mobile computing device, test-drive business rules to user data for application in the test drive interface comprises: identifying alternative product(s) or service(s) from the product-suggestion manager; and calculating the percentage difference in financial well-being between users using the test-driven product(s) or service(s) and using alternative product(s) or service(s) among users in the same segment or cohort, wherein the computer-executable program instructions of the product fit manager comprises computer-executable program instructions to: calculate the mean average for the financial well-being score for the cluster of users using the test-driven product and the well-being score for the cluster of users using the alternative product, and comparing to the financial well-being score of the user; and calculate the percentage difference in success metrics; and
wherein providing, by a product fit manager of the mobile computing device, user-specific results comprises: displaying the percentage difference in financial well-being between users using the test-driven product(s) or service(s) and using alternative product(s) or service(s) among users in the same segment or cohort.

In some embodiments, the success metrics comprise having annual income greater than annual expenses, lack of penalty interest rates incurred or penalty payments made, and reduction in net wealth by less than 15%, between users using the test-driven product and users using an alternative product among users in the same segment or cohort.

In some embodiments, the user data comprises financial account data, social media data, other application data, preferences data, transactional data, user tool data, profile data, user product history, user action history, user cohort and segmentation data or other classification data, user behavioral characteristics data, or user financial wellness assessment data. In some embodiments, the product data comprises price data, fees data, terms and conditions for use, underwriting or other approval conditions, qualitative reviews, data security practices, product classification or clustering data, referral fee data, rewards product benefit data.

In some embodiments, the disclosed method further comprising receiving community benefit provider data. In some embodiments, the disclosed method further comprising: receiving user selection of one suggested product or service; applying product-referral business rules to the selected product or service; and referring user to the selected product or service. In some embodiments, the disclosed method further comprising: applying referral-fee business rules to the referred product or service; and allocating a referral fee from a provider to a mobile application provider or an entity referring the user to the provider. In some embodiments, the disclosed method further comprising applying rewards-redemption business rules to the referred product or service; and allocating a rewards benefit to user. In some embodiments, the disclosed method further comprising: receiving a user designated financial action plan; applying financial-action-plan business rules to user data; and providing financial action plan data.

In another aspect, the novel systems and methods may demonstrate to the consumer whether and how the consumer's historical behaviors and practices would be consistent with good usage of the product or would result in issues in using the product such as by incurring additional costs. In another aspect, the novel systems and methods may demonstrate to the consumer whether and how the consumer can expect to be impacted by using the product through forward projections that would show the extent to which using the product would impact the consumer's finances, cash management preferences, budget goals, or other financial goals. In another aspect, the novel systems and methods may demonstrate to the consumer whether the consumer is likely to succeed in using the product based on a behavioral assessment of consumer in relation to the product characteristics and other user experience with the product and in relation to the consumer's finances, cash management preferences, budget goals, or other financial goals. In another aspect, the novel systems and methods may demonstrate to the consumer any alternatives to the selected product that would improve outcomes for the consumer relative to the test driven product.

As referred to herein, a “mobile computing device” is an electronic device with connectivity to a mobile network and may be, without limitation, a cellular phone or smart phone, a tablet computer, or a laptop.

A typical mobile computing device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers (which are web browsers with small file sizes that can accommodate the reduced memory constraints of wireless networks), on other user applications accessed via the graphical displays, on user applications that do not utilize a graphical display, or the like. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile computing device, the examples may similarly be implemented on any suitable computing device.

As referred to herein, an “interface” is generally a system by which a user interacts with a mobile computing device. An interface can include an input for allowing users to manipulate a mobile computing device, and can include an output for allowing the system to present information and/or data, indicate the effects of the user's manipulation, etc. An example of an interface on a mobile computing device includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface, e.g. a display screen, can offer a display window or display object, which is selectable by a user of a mobile device for interaction. The display object can be displayed on a display screen of a mobile device and can be selected by, and interacted with by, a user using the interface. In an example, the display of the mobile device can be a touch screen, which can display the display icon. The user can depress or touch the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the present disclosure may be implemented are also well-known. In a representative embodiment, a mobile computing device is connectable (for example, via WAP) to a transmission functionality that varies depending on implementation. The operating environment may be a wide area wireless network (e.g., a 2.5G network, a 3G network, or a 4G network), and the present disclosure may be implemented in other and next-generation mobile networks and devices as well. The mobile device is the physical equipment used by the end user, typically a subscriber to the wireless network. Typically, a mobile device is a 2.5G-compliant device or 3G-compliant device or a 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

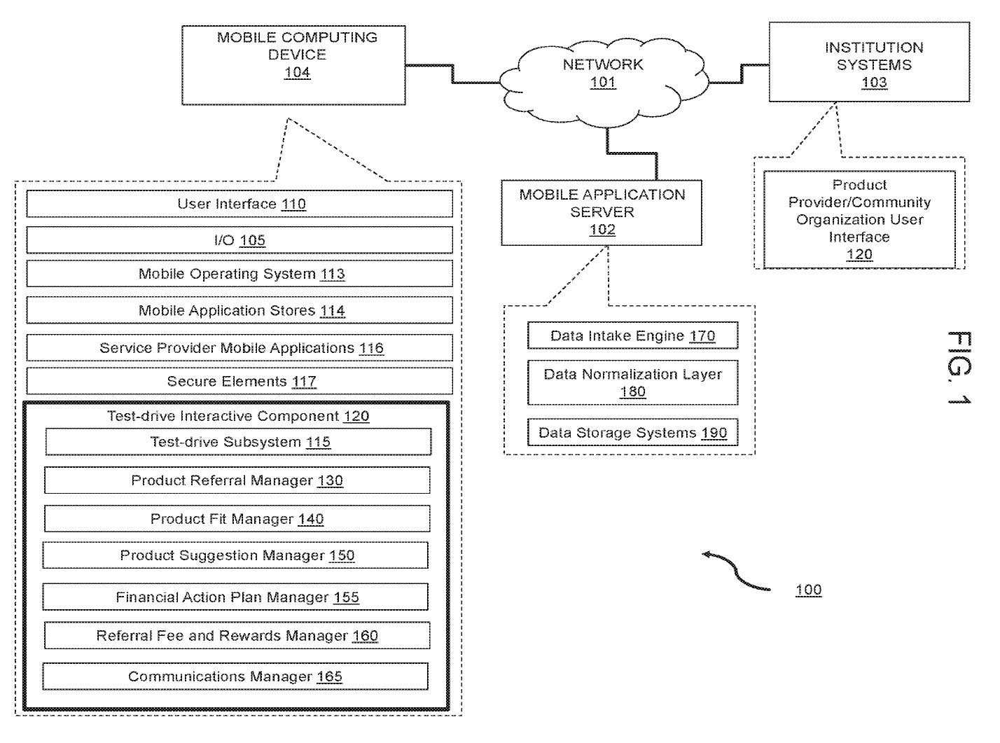

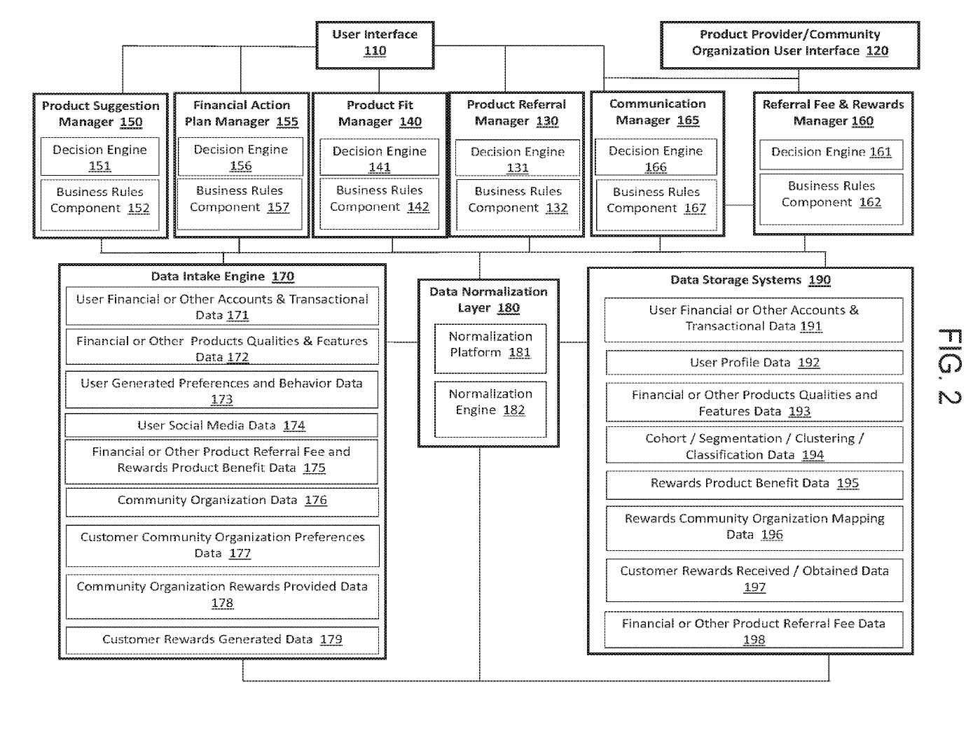

FIG. 1 is a schematic diagram of an example system 100 for providing user-specific results comprising a financial assessment that includes a look-back period, a forward projection, or both. FIG. 1 illustrates one embodiment of the system 100, and it will be appreciated that in other embodiments one or more of the systems, devices, or servers may be combined into a single system, device, or server, or be made up of multiple systems, devices, or servers.

FIG. 1 illustrates a system 100 with a network 101. The network 101 may be a global area network (GAN), such as the Internet, a wide area network (WAN), a local area network (LAN), mobile phone cellular networks, radio networks, or any other type of network or combination of networks. The network 101 may provide for wireline, wireless, or a combination wireline and wireless communication between devices on the network.

FIG. 1 also illustrates a system 100 with a mobile application server 102. While FIG. 1 illustrates an example mobile application server 102, the systems can similarly comprise an alternative server for an alternative computing device. The mobile application server 102 is operatively coupled, via a network 101, to the mobile computing device 104 and to institution systems 103, and may communicate with various components of the system 100 using suitable network components, which are not shown herein for ease of illustration. The mobile application server 102 can send information to and receive information from the mobile computing device 104 and institution systems 103 to provide a mobile application for providing user-specific results comprising a financial assessment that includes a look-back period, a forward projection, or both.

The mobile application server 102 manages communications with a test-drive interactive component 120 and provides interfaces for communication with other computer systems. The mobile application server 102 communicates with the mobile computing device 104 through the network 101, such as a mobile network, using for example security protocols such as GlobalPlatform secure channel protocol, secure sockets layer (SSL), transport layer security (TLS), and/or another security protocol. The mobile application server 102 generally comprises a communication device, a processing device, and a memory device. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device is operatively coupled to the communication device and the memory device. The processing device uses the communication device to communicate with the network 101 and other devices on the network 101, such as, but not limited to the mobile computing device 104 and the institution systems 103. As such, the communication device generally comprises a modem, server, or other device for communicating with other devices on the network 101.

The mobile application server 102 also comprises computer-readable instructions stored in the memory device, which in one embodiment includes the computer-readable instructions of a mobile application module. In some embodiments, the memory device includes data storage for storing data related to the mobile application module including but not limited to data created and/or used by the mobile application module. FIG. 1 also illustrates a system 100 including institution systems 103. The institution systems 103 are operatively coupled to the mobile application server 102 and the mobile computing device 104 through the network 101, and may communicate with various components of the system 100 using suitable network components, which are not shown herein for ease of illustration. The institution systems 103 have systems with various devices (e.g., communication device, processing device, and memory device). Therefore, the institution systems 103 communicate with the mobile application server 102 and the mobile computing device 104 in the same or similar way as previously described with respect to each system. The institution systems 103, in some embodiments, are comprised of systems and devices that allow the mobile application server 102 to access account information and/or transaction information.

FIG. 1 also illustrates a system 100 with a mobile computing device 104, which may be a mobile device. Although only a single mobile computing device 104 is depicted in FIG. 1, the system 100 may contain numerous mobile computing devices 104. The mobile computing device 104 is operatively coupled to the mobile application server 102 and institution systems 103 through the network 101, and may communicate with various components of the system 100 using suitable network components, which are not shown herein for ease of illustration. The mobile computing device 104 comprises a number of functional components. This representation of the mobile computing device 104 is meant to be for convenience of illustration and description, and it should not be taken to limit the scope of the present disclosure as one or more of the functions may be combined. Typically, these components are implemented in software (as a set of process-executable computer instructions, associated data structures, and the like). One or more of the functions may be combined or otherwise implemented in any suitable manner (e.g., in hardware, in firmware, in combined hardware and software, or the like).

The mobile computing device 104 generally comprises a communication device, a processing device, and a memory device. The processing device is operatively coupled to the communication device and the memory device. The processing device uses the communication device to communicate with the network 101 and other devices on the network 101, such as, but not limited to the mobile computing device 104 and the institution systems 103. As such, the communication device generally comprises a modem, server, or other device for communicating with other devices on the network 101. The mobile computing device 104 also comprises computer-readable instructions stored in the memory device, which in one embodiment includes the computer-readable instructions of a user module. In this way, the user module allows a user to access the mobile application.

The mobile computing device 104 may include a graphics rendering engine for displaying information to the end user in the usual manner. A wireless input/output (I/O) component 105 or any other suitable communication interface may be used for communicating data to and receiving communication data from other systems, devices, or servers via the network 101 as will be understood to those of skill in the art. The mobile computing device 104 may include an antenna for wirelessly sending and receiving communications to any other suitable communications unit.

The operation of the system can be described by the following example. As shown in FIG. 1, the mobile computing device 104 includes various functional components and an associated data store to facilitate the operation. The operation of the disclosed methods may be implemented using system components other than as shown in FIG. 1.

As shown in FIG. 1, in this example system, the mobile computing device 104 includes a user interface 110, a mobile operating system 113, mobile application stores 114, service provider mobile applications 116, secure elements 117, and a test-drive interactive component 120 that comprises test-drive subsystem 115, a product referral manager 130, a product fit manager 140, a product suggestion manager 150, and a referral fee and rewards manager 160, a financial action plan manager 155, and a communication Manager 165; all of which may be implemented by hardware, by firmware, by combined hardware and software, or the like.

The user interface 110 may include various configurations, including, but not limited to, receiving user financial or other data, receiving user selection of at least one of a product type or a service type or a financial action plan, presenting a test drive interface for each suggested product or service, receiving user selection of one of the product(s) or service(s) for test drive, providing user-specific results comprising a financial assessment that includes a look-back period, a forward projection, or both, and receiving user selection of one suggested product or service. The various user interface 110 configurations are described throughout.

For example, user financial or other data may be received through the user interface 110. For example, the user interface 110 may display user account profile setup, a survey of options to determine the user's financial preferences, prompts to permit access to social media data, or prompts to permit access to data from user financial or nonfinancial products. User account credentials may optionally be established through the user interface 110. For example, user account credentials may be established by receiving user input for establishing a user name and password; biometric credentialing, including fingerprint, face, eye scan, or voice scan; or social media or third party credentials that may be in the form of a user name or password, a biometric credentialing, or an authentication device such as an Application Program Interface (API) or a token.

The user interface 110 may be part of an application. An application may be a website, extension, or a device application that would be interacted with from a computer, a handheld phone, or any other access device, including a car dashboard, a home device like a fridge, a voice access device like a digital assistant, or a text access device like a chat tool, or a bot on any of the above.

The user interface 110 may be part of an application within an application of applications. For example, the user interface 110 may also involve a separate application that provides access to the user interface 110 as part of the separate application, e.g. by embedding the user interface 110 or some component, tool, or function of the user interface 110 into the separate application through an API of the user interface 110 or any of the components, tools, or functions of the user interface 110 or through any other kind of access mechanism.

The user interface 110 may be part of an application of applications. For example, the user interface 110 may involve an application through which financial or other product or service providers provide information to the users about their product(s), e.g. by enabling the user to obtain access to this information through the financial or other product or service provider's application incorporated into the user interface 110, embedding the provider's API into the user interface 110, or through any other means of providing the user its account information with the financial or other product or service provider in the user interface 110.

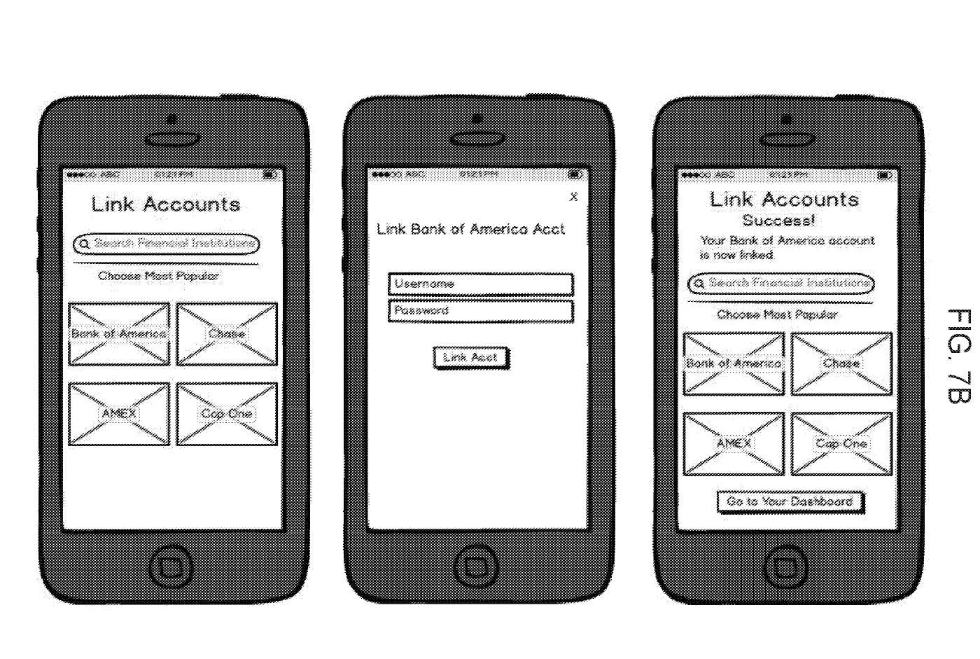

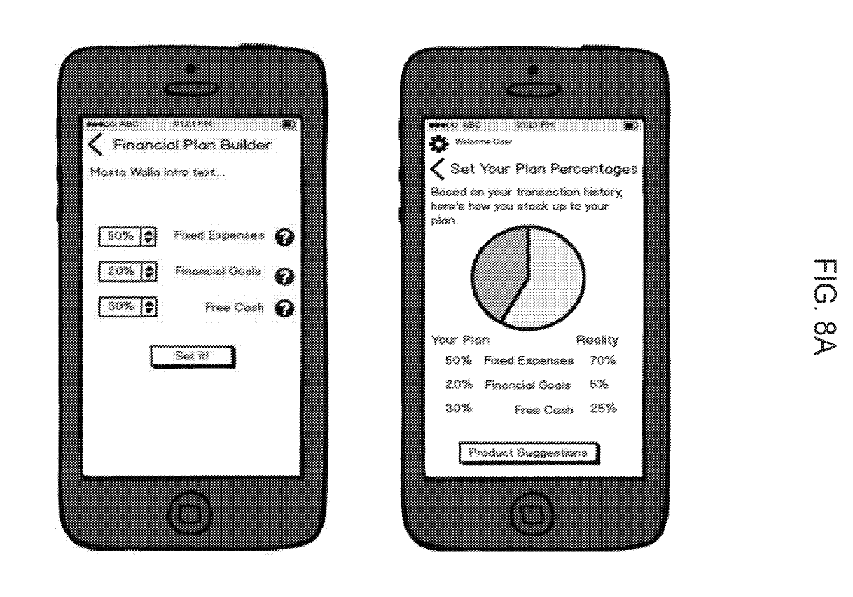

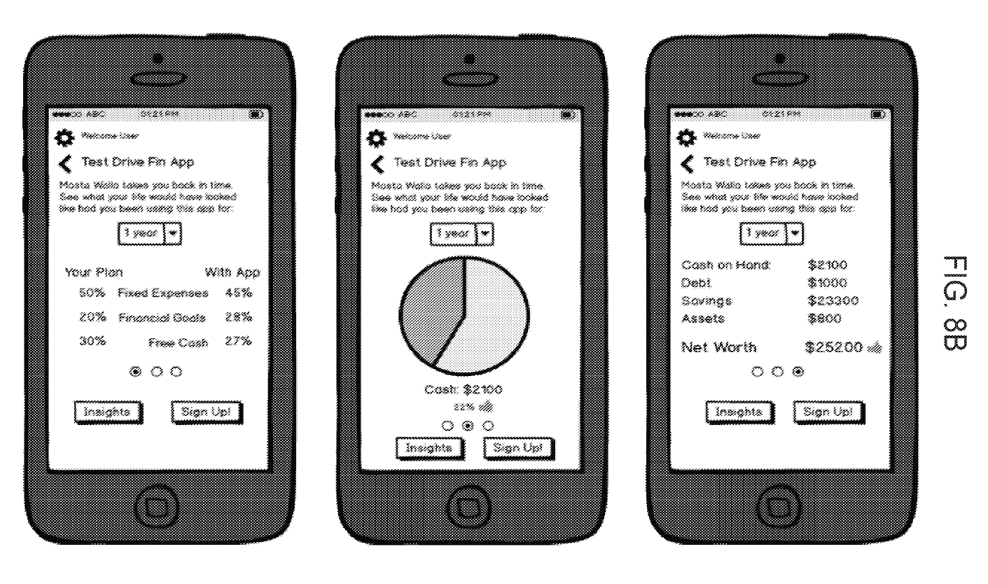

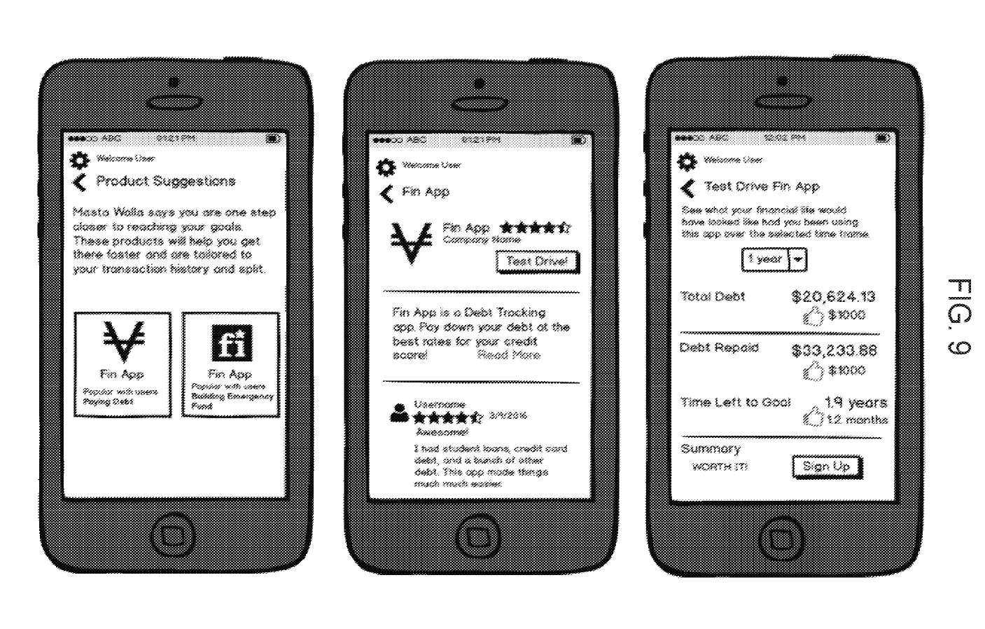

FIGS. 7A and 7B are front views of an exemplary mobile device including a user interface 110, e.g. a touch screen display for displaying prompts to receive user data and presenting suggested products according to embodiments of the present disclosure. FIG. 8A are front views of an exemplary mobile device including a user interface 110, e.g. a touch screen display for displaying prompts for receiving selection of a financial action plan and displaying financial action plan data according to embodiments of the present disclosure. FIG. 8B are front views of an exemplary mobile device including a user interface 110, e.g. a touch screen display for providing user-specific results comprising a financial assessment that includes a look-back period, a forward projection, or both. FIG. 9 are front views of an exemplary mobile device including a user interface 110, e.g. a touch screen display for displaying suggested products and prompts to receive user selection of a product or service for test drive, and providing user-specific results comprising a financial assessment that includes a look-back period, a forward projection, or both. In one example embodiment, in order to support the above-mentioned reception of user data as represented in FIG. 7B, one or more of the data elements shown below in Table 1 are provided by the institution systems 103 to the mobile application server 102.

| Field | Data Type | Description |
|---|---|---|
| account_guid | string | unique identifier of the account |
| | | (AMERICAN EXPRESS, |
| | | CAPITAL ONE) |
| amount | number | transaction amount |
| category | string | category of the transaction |
| | | (RESTAURANT, |
| | | MISCELLANEOUS) |
| created_at | string | Date/time transaction was stored, |
| | | represented in ISO 8601 format |
| | | with time stamp (e.g. 2016-01- |
| | | 01T12:02:22-0300) |
| description | string | human-readable description of |
| | | the transaction (e.g. |
| | | GODADDY.COM (480)505-8855) |
| guid | string | unique identifier of transaction |
| is_bill_pay | boolean | If the transaction is a bill |
| | | payment, this field will be true. |
| | | Otherwise, this field will be false. |
| is_direct_deposit | boolean | If the transaction is a direct |
| | | deposit, this field will be true. |
| | | Otherwise, this field will be false. |
| is_expense | boolean | If the transaction is an expense, |
| | | this field will be true. Otherwise, |
| | | this field will be false. |
| is_fee | boolean | If the transaction is a fee, this |
| | | field will be true. Otherwise, this |
| | | field will be false. |
| is_income | boolean | If the transaction is income, this |
| | | field will be true. Otherwise, this |
| | | field will be false. |
| is_overdraft_fee | boolean | If the transaction is an overdraft |
| | | fee, this field will be true. |
| | | Otherwise, this field will be false. |
| latitude | number | Latitude of the location of the |
| | | transaction (e.g. 38.89511 for |
| | | Washington, DC) |
| longitude | number | Longitude of the location of the |
| | | transaction (e.g. −77.03637 for |
| | | Washington, DC) |
| memo | string | additional descriptive |
| | | information about the transaction |
| merchant_category | string | Merchant category (e.g. internet |
| | | service provider) |
| posted_at | string | Date/time transaction was posted, |
| | | represented in ISO 8601 format |
| | | with timestamp (e.g. 2016-01- |
| | | 01T12:02:22-0300) |
| status | string | Status of the transaction (e.g. |
| | | POSTED, PENDING) |
| transacted_at | string | Date/time transaction occurred, |
| | | represented in ISO 8601 format |
| | | with timestamp(e.g. 2016-01- |
| | | 01T12:02:22-0300) |
| type | string | Transaction type (CREDIT, |
| | | DEBIT) |
| updated_at | string | Date/time transaction was |
| | | updated, represented in ISO 8601 |
| | | format with timestamp (e.g. 2016- |
| | | 01-01T12:02:22-0300) |
| user_guid | string | unique identifier of the user |

The mobile operating system 113 manages hardware resources of the mobile computing devices 104 and provides common services for executing applications and/or programs on the mobile computing device 104. Mobile application stores 114 are applications that can be used to download and install mobile applications onto the mobile devices 101. Service provider mobile applications 116 are applications provided by service providers and stored in non-transitory memory of the mobile computing device 104. Each of the service provider mobile applications 116 includes instructions that, when executed by a processor (not shown) of the mobile computing device 104, enable a user of the mobile computing device 104 to communicate with, and/or utilize one or more services provided by, the service provider. Secure elements 117 are platforms onto which service account information and corresponding applications may be added and stored. The secure elements 117 include hardware and software, and implement interfaces and protocols that enable the secure storage of service account information and applications that may be used for conducting transactions. The secure elements 117 may be implemented in different form factors, such as, for example, Universal Integrated Circuit Cards (UICC), embedded secure elements, and/or a separate chips or secure devices (e.g., a near-field communication (NFC) enabler) that can be inserted into slots on the mobile computing device 104.

A test-drive interactive component 120 is an interactive application stored in non-transitory memory of a mobile computing device 104 and includes instructions that, when executed by a processor (not shown) of the mobile computing device 104, enable a user to (1) test-drive a product or service, and (2) receive user-specific results. A test-drive subsystem 115 receives and stores data (e.g., user financial account data, user data from other products and services, feature data from financial or other products and services, user preferences data, data derived from user actions, and clustering and classification data and data derived from assessments of other data) that the test-drive interactive component 120 utilizes to perform certain functions.

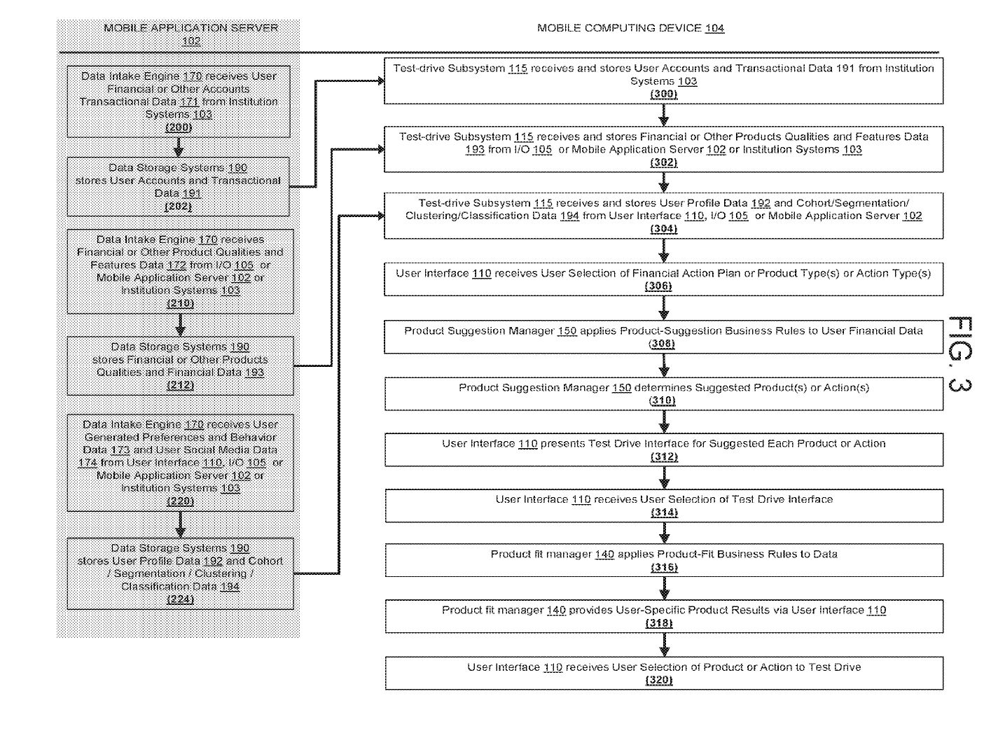

FIG. 2 is a schematic diagram of backend architecture of a system for providing user-specific results comprising a financial assessment that includes a look-back period, a forward projection, or both according to embodiments of the present disclosure

The product suggestion manager 150 is configured to display to a user certain products, services, and combinations of products and services, or financial action plans (such as Meet Expenses, Prepare for Retirement, and Purchase a House) that the user may benefit from. The product suggestion manager 150 configurations may include, but are not limited to, applying product-suggestion business rules to user data, and determining at least one suggested product or service or financial action plan based on the applied product-suggestion business rules. The product suggestion manager 150 comprises a decision engine 151 and business rules component 152 that comprises product-suggestion business rules. Product-suggestion business rules are defined by financial action plan or product or service type, and may include discrete combinations of related products, or combinations of services. The product-suggestion business rules may depend on whether the user has an existing product in the same product family or an existing service in the same service family (or combination if appropriate). For example, if the product type is credit cards, then the product-suggestion business rules may include user preferences, cohort/segment preferences, preapproval status, interest rate, credit line, annual fees, foreign transaction fees, cash advance fees, balance transfer, balance transfer fees, other fees, rewards types, rewards rules, and other terms and conditions, among other rules. For example, if the user is a 25 year old, single, and carries student debt in an amount that exceeds 10% of the user's income, the product-suggestion business rules may include a financial action plan for aggressively paying down student loan debt (which incorporates product recommendations such as personal loan consolidation products or debt payment products as well as action recommendations such as allocating 30% of income to this financial action plan goal or decreasing monthly non-fixed expenses by 10% and allocating that income to each month's student loan payment).

The user interface 110 may list the products, organize products by type, and enable the user to explore the products by specific product type, such as car loan, home loan, student loan, credit card, home insurance, among other types.

The decision engine 151 may be configured to apply the product-suggestion business rules for selected product type(s) and/or service type(s) to available financial or other provider products/services of that type, and user data (e.g. the user's financial accounts and transaction data, such as the features of any of the user's existing products or actions in the same product or service family; and the user's profile data, such as defined preferences, plans, budgets, and tools, and other data that corresponds to the user). The decision engine 151 incorporates and weights data from the user's selected preferences, from the user's associated segment or cohort, from the user's historical financial behavior and performance, from the user's defined financial action plan or other tools, as well as data derived from this data or from the data of other users that would provide for customized suggestions for the user. For example, credit card suggestions would be produced based on a weighted average calculation of the user's cohort/segment attributes, the user's defined preferences and goals, a comparison with the features of the user's current credit card product(s), the user's historical financial transactions and exhibited behavior, historical financial transaction and exhibited behavior of other users, as well as data derived from this data or from the data of other users. The decision engine 151 uses various techniques to assess the above data and predict categories to produce customized suggestions for the user, by employing regression analysis, multiclass classification algorithms, and clustering algorithms. For example, decision engine 151 could generate credit card recommendations using item-based collaborative filtering, or other model-based algorithms for making recommendations. Using this algorithm, the similarities between the different credit cards in the dataset are calculated using one or more similarity measures. These similarity measures are then used to predict ratings for user-item pairs not present in the dataset. A similarity value between two credit cards would be measured through an analysis of all the users who have rated both of the credit cards. A credit card can be rated through a specific ranking system or through specific use of the card. A user who consistently uses a specific card can be assumed to rank the credit card highly for comparison purposes. As some users might rate items highly in general while others may give preference to a lower rating, adjusted cosine similarity would be used to remove that drawback from the similarity comparisons. Adjusted cosine similarity works by subtracting the average ratings for each user from each user's rating for the pair of credit cards in question. Mathematically, the formula for adjusted cosine similarity is as follows:

$$sim ( i , j ) = \frac{{\sum }_{u ∈ U} ( {R}_{u , i} - {\overline{R}}_{u} ) ( {R}_{u , j} - {\overline{R}}_{u} )}{\sqrt{{\sum }_{u ∈ U} {( {R}_{u , i} - {\overline{R}}_{u} )}^{2}} \sqrt{{\sum }_{u ∈ U} {( {R}_{u , j} - {\overline{R}}_{u} )}^{2}}}$$

With this model and using adjusted cosine similarity as the similarity measure, we would predict the rating for any user-credit card pair by using a weighted sum. The decision engine 151 compiles all credit cards matched by the model as similar to a target credit card and filters all credit cards that the active user has rated. The active user ratings are weighted by the similarity between the rated credit card and the target credit card. The prediction is scaled by the sum of similarities to get a predicted rating. The decision engine would return as recommendations credit cards with high predicted ratings. The recommendation set can be further filtered through additional predictive filtering, such as whether the credit card represents a savings opportunity for the user and whether the user appears to qualify for the underwriting terms set by the credit card provider and whether the particular card is consistent with the user's preferences and financial action plans (for instance, user has a financial action plan to get out of debt and credit cards that would not support automated monthly in full pay downs will be demoted). In addition, the decision engine 151 will use algorithms such as decision trees, random forests and gradient boosts to find attributes that positively or negatively impact user performance with a product as well as to compare multiple products and services against each other but relative to the user data described above, and in particular, the user's selected preferences and financial action plans. For example, credit cards would be stored and classified by certain variables, such as APR, Bank, type of card (travel, cashback), minimum credit score, income level, user category (high income, international travelers). Users would be stored and classified by certain attributes, such as age, gender, income, category (high income, international traveler), marital status, family size, financial action plan. The decision engine 151 would apply a categorical variable decision tree to decide which attributes are the most significant variables for a given outcome, such as credit card use. Categorical variable decision trees are decision tree algorithms used for categorical target variables, such as whether a user will use a credit card or not. The Chi-square algorithm is selected to calculate the statistical significance between the differences with sub-nodes and parent nodes. It is measured by taking the sum of squares of standardized differences between observed and expected frequencies of target variables. Using the attribute, gender, as an example the decision engine 151 would apply categorical variable decision trees using Chi-square algorithm to decide where best to split a node into sub-nodes. The pseudo steps for the above example would be:

Start populating the female node with the actual value of female users who use the target credit card
calculate the expected value for “use credit card” and “not use credit card”
calculate deviations by using formula, Actual−Expected
calculate Chi-square of node for “use credit card” and “not use credit card” using formula:

((Actual−Expected\hat{ }2/Expected)\hat{ }1/2)

follow above steps for calculating Chi-squre value for male node
add all Chi-squre values to calculate Chi-squre for the split on the Gender attribute

A tabular representation of the results can be found below. Note that the actual numbers are for illustrative purposes only.

| | | | | | | | | Chi- | Chi- |
|---|---|---|---|---|---|---|---|---|---|
| | | | | Expected | Expected | Deviation | Deviation | square | square |
| | | Not use | | Use | Not Use | Use | Not Use | Use | Not use |
| | Use credit | credit | | Credit | Credit | Credit | Credit | Credit | credit |
| Node | card | card | Total | Card | Card | Card | Card | Card | card |
| Female | 12 | 88 | 100 | 55 | 55 | −43 | 33 | 5.8 | 4.45 |
| Male | 133 | 77 | 200 | 100 | 100 | 33 | −23 | 3.3 | 2.3 |

| | |
|---|---|
| Total Chi-Square | 15.85 |

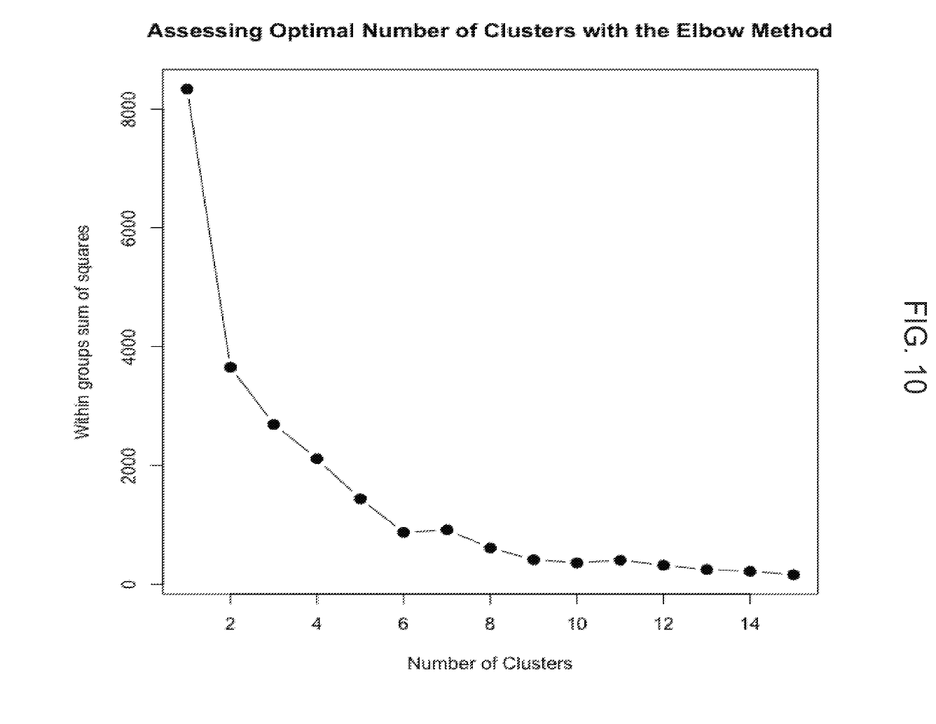

The above process would be repeated for the other attributes and the decision engine 151 would identify the attributes with the highest Chi-square total as more significant for the given outcome. In addition, classification algorithms such as the K-nearest neighbors algorithm, permit both inventory categorization (such as grouping inventory by sales or referral activity or production metrics) as well as behavioral segmentation of users (such as by purchase history, activities on platform, personal attributes based on interests and behaviors, and profiles based on activity monitoring) to inform the assessment of products and services and suggestions to users by employing the concept that users that have agreed in the past are presumed to agree in the future.
The decision engine 151 will use a K-means clustering algorithm to find collections of features data—or groups—which had not been explicitly associated or labeled, and which can inform the fitness of products and services to specific users or cohorts/segments of users. For example, K-means clustering would be used to create segments within product types, such as credit cards, to segment like cards. This similarity would be used by the decision engine 151 in order to make appropriate recommendations based on similarity. The decision engine 151 would use only those attributes that were designated as most significant by the categorical decision tree algorithm as described previously. The K-means clustering algorithm would partition the credit card product dataset into distinct, exclusive clusters whereby the data points in each cluster are similar to each other. The pseudo steps for applying K-means clustering to the credit card product dataset are as follows:
define the number of clusters. Initially the Elbow method would be used to define the initial number of clusters. The Elbow method involves observing a set of possible numbers of clusters relative to how they minimize the within-cluster sum of squares. In other words, the Elbow method examines the within-cluster dissimilarity as a function of the number of clusters. For our example, we will use an initial number of clusters of 6. FIG. 10 is an example plot of the Elbow method for defining the number of clusters.
assign each individual credit card to one of the clusters randomly
calculate the centroid of each cluster (mean within the cluster)
measure the within-cluster variation using squared Euclidean distance, an algorithm for measuring the Euclidean distance between two points, for all points relative to the centroid
apply iterative refinement process to minimize within-cluster variation until no major differences are found

The iterative refinement process repeats the random assignment of credit card data points to a cluster, calculates the new centroid (mean within the cluster), and assigns the credit card to its nearest centroid. The representation below demonstrates the results of applying the K-means clustering algorithm for a dataset of 48 credit cards using the attributes “APR” and “rewards_rate”.

K-means clustering with 6 clusters of sizes 18, 18, 4, 6, 3, 1

| | Cluster | | |
|---|---|---|---|
| | Means: | Rewards | Within Cluster |
| Cluster Number | APR | Rate | Sum of Squares |
| 1 | 13.208750 | 0.953125 | 33.386720 |
| 2 | 16.160000 | 2.500000 | 53.665400 |
| 3 | 22.240000 | 0.812500 | 20.171880 |
| 4 | 12.391670 | 4.333333 | 10.793420 |
| 5 | 0.000000 | 2.666666 | 12.666670 |
| 6 | 15.990000 | 12.000000 | 0.000000 |

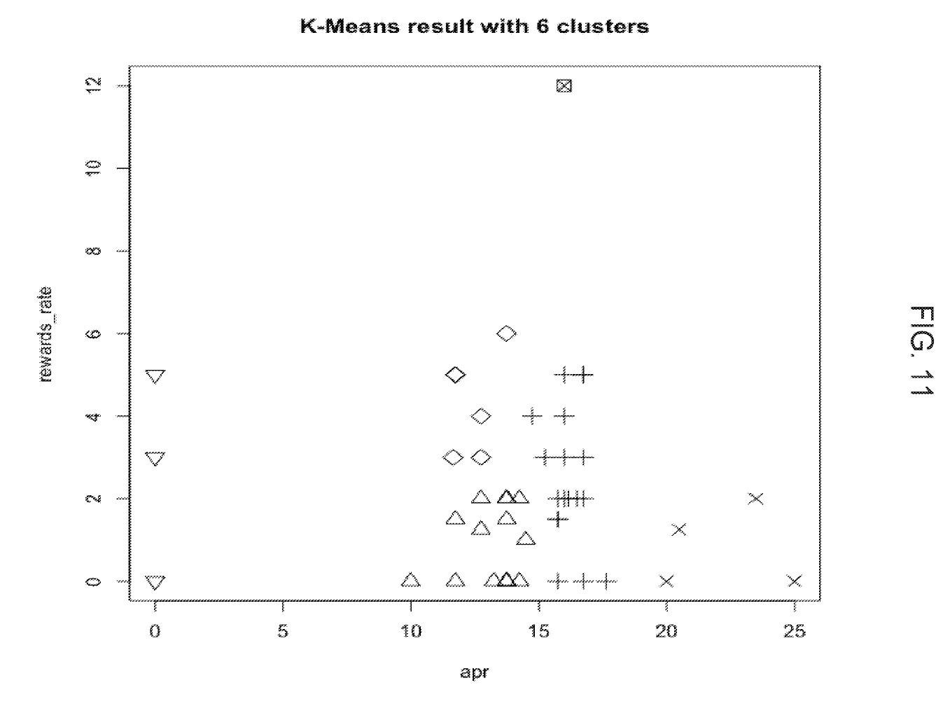

FIG. 11 is an example plot of the clusters as calculated above using K-means clustering. The data elements with similar symbols correspond to a specific cluster.

The product suggestion manager 150 presents to the user, via the user interface 110, a defined list of suggestions for each product or service type or at a particular step within a financial action plan. The user interface 110 may further suggest financial or other products or actions that would enable the user to maximize the benefits from using a suggested product or a suggested service. The product suggestion manager 150 may display suggested product(s) and/or service(s) in a product marketplace of the user interface 110 or other areas of the user interface 110, such as any landing page or dashboard. Display of suggested product(s) and/or service(s) may be visually demonstrated according to their relative weights or scores. A product marketplace of the user interface 110 may be in visual and/or voice formats and can provide the user with the ability to explore available financial or other products. A product marketplace of the user interface 110 may provide the user with access to information from product or service providers, by embedding the provider's API, or any other means of the provider.

The financial action plan manager 155 is configured to enable the user to set up plans, goals, preferences, rules, limits, and actions in a financial action plan, and employ tools, products, and services related to the financial action plan. The financial action plan manager 155 configurations may include, but are not limited to, applying financial action plan business rules to user financial or other data (e.g. user profile data, user historical financial transactions and behaviors, user data from other applications), applying financial action plan business rules to a suggested product or service, and providing financial action plan data. The financial action plan manager 155 comprises a decision engine 156 and business rules component 157 that comprises financial action plan business rules.

The financial action plan business rules depend on a user designated financial action plan, e.g. that is based on either (i) user selection of one or more recommended financial action plans, or (ii) user establishing a customized financial action plan. Financial action plans may include traditional financial management decisions, such as setting a financial plan, budget, or cash management preferences, or experiences that contain one or more financial components, such as becoming a home owner, having a child, learning to cook, or organizing a party. For the designation of a financial action plan, the financial action plan manager 155 may be configured to display, via the user interface 110, recommended financial action plans or a customization tool for the user to set forth personalized financial action plan components. The user interface 110 may provide the user the ability to set a financial action plan, which may include the user consenting to adopting a recommended financial action plan or the user defining its own customized action plan, which may include clusters of financial components such as spending limits, spending rules, financial goals such as savings goals, spending goals, debt repayment goals, or any other goal that has a financial component, financial action plan tools such as auto savings and auto investing, and any other type of financial component. Recommended financial action plans may be based on a user's existing financial products, user financial transactions and behavior data, user preferences data, or data regarding preferences attributed to a user's cohort or segment. Recommended financial action plans may provide for clusters of different financial components as above, which may be created to cover a current financial status, a financial type, or a user-specific scenario. A user-specific financial action plan would use the user's profile, available financial data, characteristics, and practices, to determine the components of the clusters for the specific user.

The user interface 110 may provide a Budget Tool that would permit the user to define a budget for categories of allocating income (e.g., spending), such as fixed expenses, savings goals, or freely spendable income. The Budget Tool may include demonstrating the user's current allocation of income, establishing the user's budget based on the service's proprietary budget tools, permitting the user to define its own customized budget, and providing insights or suggestions for how the user could meet its budget, including through customized tool or product suggestions as determined by the product suggestion manager 150.

The user interface 110 may provide a Cash Management Tool that would permit the user to access cash management tools, which may include demonstrating the user's current cash management practices, establishing the user's cash management needs based on the service's proprietary cash management tools, permitting the user to set customized cash management needs, providing tools to enable the user to meet its cash management needs, and providing insights or suggestions for how the user could meet its preferred cash management needs, including through customized tool or product suggestions as determined by the product suggestion manager 150 and presented to the user pursuant to business rules and/or made available for the user to access at any time.

The user interface 110 may provide other account tools such as product guides, financial management guides, financial education guides, among other things, and programs or modules of the above, and may be presented to the user pursuant to business rules or made available for the user to access at any time.

The decision engine 156 is configured to conduct a gap assessment at defined intervals to produce financial action plan data (e.g. data from an assessment of a user designated financial action plan against user data, such as the user's historical, current, or projected financial transaction and behavior data, or against a suggested product or service; including data based on user data and user compliance with the user designated financial action plan). The data produced through this assessment may be derived by and incorporated into the business rules and other financial action plan manager components through statistical analysis and machine learning techniques as conducted by decision engine 141 in the manner described herein, and/or decision engine 151 in the manner described herein, and may be presented to the user according to the business rules or otherwise made available for the user to access at any time. For example, decision engine 151 may result in the creation of user clusters by product type with the clusters as described herein, resulting in the creation of Cohort/Segmentation/Clustering/Classification data 194. Further, in this example embodiment, for a user financial action plan of “Purchase a Home”, decision engine 156 conducts a numerical computation to assess whether the user is conforming to the spending and saving limits embedded in the user's current plan step of “saving for a downpayment”; and to the extent the user is not conforming to the limits, the financial action plan decision engine 156 may incorporate a new suggestion for the user to obtain an automated savings application, and will embed in the financial action plan data the suggestions for automated savings applications for the user's cohort that are produced through the analysis conducted by decision engine 151 and described herein.

The financial action plan manager 155 may also be configured for determining at least one suggested product, service, or tool based on applied financial action plan business rules. Alternatively, the product suggestion manager 150 configurations may also include, applying product-suggestion business rules to financial action plan data, and determining at least one suggested product, service, or tool based on the applied product-suggestion business rules, wherein the at least one suggested product, service, tool enables the user to comply with a user designated financial action plan.

The user interface 110 may display the user's current financial management practices and the difference between the user's financial action plan and the user's historical financial practices. The user interface 110 may display suggestions, based on the user's financial action plan and historical financial practices, for additional financial action plan tools that the user could incorporate into its financial action plan that would assist the user in meeting its financial action plan. The user interface 110 may display suggestions, based on the user's financial action plan and historical financial practices, for products that would enable the user to meet or adhere more closely to a financial action plan. The user interface 110 may display suggestions, based on the user's financial action plan and historical financial practices, for practices, behaviors, insights, or suggestions that would enable the user to meet or adhere more closely to a financial action plan.

The product fit manager 140 is configured to enable a user to quantitatively and qualitatively verify the proof of value to the user of a financial or other product that the user may obtain or a financial or other service that the user may take and demonstrate whether the product or service has a good fit for the user, given the user's needs and interests and behavioral characteristics. The product fit manager 140 configurations may include, but are not limited to, presenting a test drive interface for each suggested product or service (or combination of products and/or actions), applying test-drive business rules to user data for application in the selected test drive interface, and providing user-specific results comprising a financial assessment that includes a look-back period, a forward projection, or both. The product fit manager 140 comprises a decision engine 141 and business rules component 142 that comprises test-drive business rules.

The decision engine 141 will apply the test-drive business rules for the product(s) and/or service(s) to the features of the product(s) and/or service(s) selected for analysis/test drive in order to assess for the user the financial impacts or results from using the product(s) and/or service(s). In other words, the decision engine 141 produces user-specific results that demonstrates to the user the effect on the user's historical financial behavior and performance as though the user had in fact used the selected product(s) or service(s) over a specified period of time and projects a forward assessment to consider the impact on the user's finances, selected budget, cash management preferences and financial action plan(s). The decision engine 141 also models the user's likelihood of success in using the product or maintaining the service based on a comparison of the user's data and behavioral characteristics with other user data and behavioral data. The results also may show alternative product(s) or service(s) that may be better for the user than the test-driven product or service, or actions that the user could take to minimize or eliminate any negative impacts or additional financial action plans that the user could set to deal with the consequences of the test-driven product(s) or service(s) and provide a separate test drive interface for the alternative product(s) or service(s).

As a further description of the decision engine 141, the decision engine 141 incorporates data from the user's existing financial or other products and services accounts, the features of the selected product(s) or service(s) for test drive, the features of any of the user's existing products or actions in the same product family, user's financial behavior data, user's financial performance data, the user's defined preferences, plans, and tools, such as a financial action plan, and other data that corresponds to the user, other user financial behavior data, other user financial performance data, the features of other user's existing products or actions, other user's defined preferences, plans, and tools, such as a financial action plan or financial action plans, as well as data produced through an assessment of the data above, such as cohort/segment attributes or categories of data, and data produced from prediction employing algorithms or clustering algorithms to analyze the data above. For instance, a credit card test drive will be produced based on a weighted assessment of the user's cohort/segment attributes, the user's defined preferences and goals, a comparison with the features of the user's current credit card product(s) and use and behavior with these product(s), the user's historical financial transactions and exhibited behavior, and the historical financial transaction and exhibited behavior of other users. The decision engine 141 uses various techniques to synchronize and assess the data, and would predict values by employing numerical computations and regression analysis, and would predict categories by employing regression analysis and multiclass classification algorithms as well as clustering algorithms, to produce a test drive application in the test drive interface or other part of the user interface for the user in order to demonstrate to the user (1) whether and how the user's historical financial behaviors and outcomes would be affected as if the user had been using the product, (2) whether and how the user's historical behaviors and practices would be consistent with good usage of the product or would result in issues in using the product such as by incurring additional costs, (3) whether and how the user can expect to be impacted by using the product through forward projections that would show the extent to which using the product would impact the user's cash management preferences, budget goals, or other financial action plans, (4) whether the user is likely to succeed in using the product based on a behavioral assessment of user in relation to the product characteristics and other user experience with the product and in relation to the user's cash management preferences, budget goals, or other financial action plans and (5) whether any alternatives to the selected product may improve outcomes for the user relative to the test driven product.

As a further description of the decision engine 141, to demonstrate test-drive outcome (1), the decision engine 141 would employ numerical computations to determine absolute and relative changes to user's expenses, income, debt, assets, and net worth across the user's historical timeframes that would result from using the product or service (hereinafter, both referred to as a product for ease of reference). For instance, a credit card test drive would use a direct computational method to compute the changes in user's historical expenses, income, debt, assets, and net worth by e.g., 3, 6, 9, and 12 months. In this example embodiment, a user would select a test drive of a credit card s/he does not currently use with the following key attributes: (a) APR: 13.74% and (b) no foreign transaction fee. The decision engine 141 would build the test drive results by applying these attribute values to the user's historic transactions and applying summarization methods to the newly calculated dataset to compare against the user's actual historical transactions. The tabular representation below provides an example representation or the comparative result to select transactions from the active user's current credit card with the following key attributes: (a) APR: 15.66% (b) Foreign transaction fee: 2.7%:

| | | | | | for- | look- | lookback_for- |
|---|---|---|---|---|---|---|---|
| txn_type | txn_date | txn_description | txn_amt | is_foreign_txn? | eign_txn_amt | back_foreign_txn_amt | eign_txn_amt_difference |
| sale | Jan. 2, 2016 | Foreign | 20.12 | y | 0.54 | 0.00 | −0.54 |
| | | vendor 1 | | | | | |
| sale | Jan. 12, 2016 | Foreign | 192.29 | y | 5.19 | 0.00 | −5.19 |
| | | vendor 2 | | | | | |
| sale | Jan. 22, 2016 | Domestic | 52.72 | n | n/a | n/a | n/a |
| | | Vendor 1 | | | | | |

In the table representation above, the decision engine 141 would apply the key attributes of the credit card selected for test drive to the relevant historical transactions for the active user (e.g., decision engine 141 would then calculate the difference between the lookback calculation and the historical calculation using the following formula: lookback_foreign_txn_amt_difference=(lookback_foreign_txn_amt−foreign_txn_amt). The decision engine 141 would then create summary statistics for the lookback timeframes, e.g., 3-months, broken down by month. The representation summary below calculates the arithmetic sum of all transaction amounts, the arithmetic sum of all foreign transaction amounts, and the arithmetic sum of the calculated difference between the actual foreign transaction fees and the calculated lookback foreign transaction fees.

| | | | SUM |
|---|---|---|---|
| Month | SUM_txn_amount | SUM_foreign_txn_amt | lookback_foreign_txn_amt_difference |
| January | $2,789.00 | $97.00 | −$97.00 |
| February | $5,298.23 | $248.82 | −$248.82 |
| March | $3,429.97 | $84.22 | −$84.22 |

The decision engine 141 would then recalculate the relative increase or decrease in the amount due for a given month using the formula: lookback_credit_card_monthly_total=SUM_txn_amt−SUM_lookback_foreign_txn_amt_difference (e.g., $2692.00 in the example above for January). The decision engine 141 would then recast the active user's finances based on the recalculated lookback totals. For example, for January in the example above, the newly calculated lookback total is $97.00 less than the actual credit card total. The decision engine 141 would apply the payment to the newly calculated lookback total for a given month (e.g. January) and then calculate summary statistics for the timeframe (e.g. 3-months). The tabular representation below shows the resulting summary statistics for the test drive lookback period for this example embodiment:

Test Drive Lookback Summary for 3-month Period

| | Actual | Lookback | Difference |
|---|---|---|---|
| Net Worth | $125,000.00 | $126,100.00 | $1,100.00 |
| Total Debt | $30,000.00 | $28,000.00 | −$2,000.00 |
| Cash | $1,500.00 | $1,520.00 | $20.00 |
| Investments | $153,500.00 | $153,500.00 | $0.00 |

The decision engine 141 would send the resulting summary to the user interface 110.

As a further description of the decision engine 141, to demonstrate test-drive outcome (2), the decision engine 141 would determine the historical months in which the user would face difficulty in or failure to meet expenses if the user were using the product, provide user aggregate data on the frequency of difficult or failure months compared to the entire time series (by e.g., 1, 3, 6, 9, 12 months), and determine user historical behaviors that support or detract from successful use of the product. For example, a credit card test drive would employ a numerical computation method to calculate the mean variation of user's expenses to income ratio and determine whether the new product or service increases expenses or decreases income in any month by an amount in excess of the mean variation (considered a “difficulty month”), as well as determine whether the new product or service increases expenses or decreases income in any month to such an extent that the user's expenses are greater than income (considered a “failure month”). In addition, in this example embodiment, the credit card test drive would use numerical computation to calculate the aggregate data on the frequency of difficult or failure months compared to the entire user historical time series (e.g., by 1, 3, 6, 9, 12 months) to demonstrate severity to the user on a proportional basis (e.g., user would experience difficulty for 2 out of 6 months and failure for 1 out of 6 months, in the aggregate user would be unsuccessful in using product for 50% of the time). A user might test drive a credit card with a higher APR than their current credit card yet with a higher rewards rate. The decision engine 141 would build the test drive results by applying the attribute values to the user's historic transactions and applying summarization methods to the newly calculated dataset to compare against the user's real historical transactions. The tabular representation below provides an example representation of the comparative result to select transactions from the active user's current credit card with the following key attributes: (a) APR: 17.25% ;(b) rewards rate: 1 miles per dollar spent. The test drive credit card has the following key attributes: (a) APR: 22.20%; (b) rewards rate: 2 miles per dollar spent:

| | | | | | | lookback_re- |
|---|---|---|---|---|---|---|
| txn_type | txn_date | txn_description | txn_amt | rewards_rate | lookback_rewards_rate | wards_rate_difference |
| sale | Jan. 2, 2016 | vendor 1 | 20.12 | 20 | 40 | 20 |
| sale | Jan. 12, 2016 | vendor 2 | 192.29 | 192 | 384 | 192 |
| sale | Jan. 22, 2016 | vendor 3 | 52.72 | 52 | 104 | 52 |

Similar to the method as described in the example embodiment in paragraph 0089 above, the decision engine 141 would apply the key attributes of the credit card selected for test drive to the relevant historical transactions for the active user. The decision engine 141 would then calculate the difference between the lookback calculation and the historical calculation using the following formula in the case of rewards rate: lookback_rewards_rate_difference=(lookback_rewards_rate−rewards_rate). The decision engine 141 would then create summary statistics for the lookback timeframes, e.g., 3 months, broken down by month. The representation summary below calculates the arithmetic sum of all transaction amounts, the historical interest calculated using APR, the test drive lookback calculated interest using the test drive credit card APR, the difference between the historical interest and the test drive lookback calculated interest, the arithmetic sum of rewards amounts based on the historical rewards amount, the test drive lookback rewards amount, and the arithmetic sum of the calculated difference between the actual rewards amount and the calculated lookback rewards amount.

| | | | | | | SUM | SUM |
|---|---|---|---|---|---|---|---|
| | | | SUM | | SUM | lookback | rewards |
| | | SUM | lookback | interest | rewards | rewards | amount |
| Month | SUM_txn_amount | interest | interest | difference | amount | amount | difference |
| January | $2,789.00 | $481.10 | $619.16 | $138.06 | 2789 | 5578 | 2789 |
| February | $5,298.23 | $913.94 | $1,176.21 | $262.27 | 5298 | 10596 | 5298 |
| March | $3,429.97 | $591.67 | $761.45 | $169.78 | 3429 | 6858 | 3429 |

The decision engine 141 would then recast the active user's cash flow based on the recalculated lookback totals. For example, for January in the example above, the newly calculated lookback interest total is $138.06 higher than the historical credit card interest total. The decision engine 141 would apply the historic credit card payment to the newly calculated lookback amount due for a given month (e.g., January) and then calculate summary cash flow statistics for the timeframe (e.g., 3 months). If the active user paid the credit card in full each month during the timeframe, the decision engine 141 would ignore any interest calculated when recasting cash flow. If the user historically paid credit card interest due to not paying the credit card balance in full each month, the decision engine 141 would retroactively apply the historical payment to the newly calculated balance and recast cash flow for the timeframe accordingly. The tabular representation below shows the resulting cash flow summary statistics for the test drive lookback period for an example embodiment of a user who paid interest during the lookback timeframe (e.g., 3 months):

Test Drive Lookback Summary for 3 month Period

| | | Actual Total | Lookback Total | Net Cash flow |
|---|---|---|---|---|
| | Income | Expenses | Expenses | Difference |
| January | $10,000.00 | $10,230.12 | $10,368.18 | −$368.18 |
| February | $10,000.00 | $12,220.88 | $12,483.15 | −$2,483.15 |
| March | $10,000.00 | $9,232.72 | $9,402.50 | $597.50 |
| Net | $30,000.00 | $31,683.72 | $32,253.83 | −$2,253.83 |

The decision engine 141 calculates historic income, the sum of the actual total expenses in the given month, the lookback total expenses in the given month (which include the additional interest calculation as mentioned above), and the net cash flow for the given month. In this example embodiment, the net cash flow is negative for both January and February. The decision engine 141 would calculate January and February as failure months. The decision engine 141 would calculate the ratio of expenses to income for March, a net cash flow positive month, as historically 92.33% and 94% for the test drive lookback calculation. In this example embodiment the ratio threshold for a difficulty month is 93%. The decision engine 141 would therefore calculate March as a difficulty month. Furthermore, for example, a credit card test drive would employ hierarchical clustering and dimension-reduction algorithms to define classes or clusters of users that the user belongs to, and then finding characteristics in the class that are statistically significant in predicting success or failure in using the product, and then identifying whether the user has those characteristic(s). Success in using the product would be defined, for example, by user having annual income greater than annual expenses, lack of penalty interest rates incurred or penalty payments made, reduction in credit score by less than 100 points, and reduction in net wealth by less than 15%. Failure in using the product would be defined, for example, as the failure to satisfy one of the metrics above. For example, the user dataset for a test drive of credit card has several categorical/ordinal variables, such as demographic information. To generate clusters, we need to first calculate a dissimilarity matrix of the dataset. “Gower' s distance”, a well-known algorithm for calculating dissimilarity for categorical variables, would be used for the user dataset. The steps required for clustering are as follows:

calculate dissimilarity distance using “Gower's distance”, which computes all pairwise dissimilarities (distances) for observations in the dataset with mixed data types (e.g. categorical and numerical)
apply k-means clustering (elbow method) as described in paragraphs 0073-0076 to calculate optimal number of clusters
apply h-clustering to group categorical variables
generate cluster profiling
compare active user profile to cluster profiles with desired outcome (e.g. success using the test drive credit card).

Below is a tabular representation of the first 4 records of the dataset for this example embodiment:

| record_number | variable_1 | variable_2 | variable_3 | variable_4 | variable_5 |
|---|---|---|---|---|---|
| 1 | 5.1 | 3.5 | 1.4 | 0.2 | category_1 |
| 2 | 4.9 | 3 | 1.4 | 0.2 | category_1 |
| 3 | 4.7 | 3.2 | 1.3 | 0.2 | category_3 |
| 4 | 4.6 | 3.1 | 1.5 | 0.2 | category_2 |

Gower's Distance between two rows is calculating by taking the weighted mean of the contributions of each variable. The specific formula is:

$${d}_{ij} = d ( i , j ) = \frac{{\sum }_{k = 1}^{p} {w}_{k} {δ}_{ij}^{( k )} {d}_{ij}^{( k )}}{{\sum }_{k = 1}^{p} {w}_{k} {δ}_{ij}^{( k )}} .$$

Gower's distance first computes distances between pairs of variables and then combines those distances into a single value for each record-pair. For our example embodiment, the decision engine 141 would calculate the number of clusters for the users using the elbow method for applying K-means clustering as previously described in paragraphs 0073-0076. For our example embodiment, the elbow method resulted in 6 clusters for users. The decision engine 141 would then apply hierarchical, agglomerative clustering (h-clustering) of the dissimilarity data as previously calculated using “Gower's method”. Agglomerative hierarchical clustering is a well-known algorithm used to perform a hierarchical cluster analysis using a set of dissimilarities. H-clustering will result in groups of related users. A tabular representation of the resulting clusters, (A-F for our example embodiment), is below:

| A | B | C | D | E | F |
|---|---|---|---|---|---|
| 21119 | 8691 | 967 | 30878 | 17540 | 27144 |

The letters correspond to a distinct cluster and the values are the number of users within the cluster. The decision engine 141 then profiles the clusters. Cluster profiling characterizes the clusters in terms of similarities and differences. The decision engine 141 performs profiling by analyzing all variables against clusters and seeing both the similarities and differences. For example, a variable “having annual income greater than annual expenses” would be compared and contrasted for each of the calculated clusters, A through F. A tabular representation can be seen below:

| A | B | C | D | E | F |
|---|---|---|---|---|---|
| Yes | No | No | Yes | No | No |

By creating an analysis matrix in this way of all variables for each cluster, the decision engine 141 creates a cluster profile. An example cluster profile for cluster A in our example embodiment is below for five example variables.

| | is_annual_income_greater_than_expenses? | median_income | median_networth | expenses_ratio | median_credit_score |
|---|---|---|---|---|---|
| A | Yes | $30,000.00 | $27,000.00 | 0.4 | 600 |

By calculating a cluster profile in this way, the decision engine 141 would then match the active user's profile signature to one of the calculated profiles. The decision engine 141 would then calculate the likelihood of success of using the test drive product by comparing how successful the test drive product is with the matched profile cluster based on defined success metrics.

As a further description of the decision engine 141, to demonstrate test-drive outcome (3) above, the decision engine 141 would predict the user's absolute and relative changes in expenses, income, debt, assets, and net worth across forward-looking timeframes from using the product, compare these results to the results obtained by the assessment of the user's historical transactions described above, and identify drivers for the differential in results. In addition, the decision engine 141 would predict the user's absolute and relative changes to compliance with the user's cash management or budgeting preferences and other financial action plans. For instance, a credit card test drive would use numerical calculation to compute the user's absolute and relative changes in expenses, income, debt, assets, and net worth across forward-looking timeframes. Moreover, a credit card test drive would employ, for example, a linear regression, such as the Markov Chain Monte Carlo method, to simulate changes in interest rates as well as user expenses and income, and add these simulations to the calculation described above. A credit card test drive would also employ classification algorithms like multiclass classification algorithms such as a multiclass decision forest to identify segments and cohorts for the user, and assess those segments and cohorts to identify mean average expenses and income by age parameters in order to project the user's expenses and income at future points, with slope points being determined through linear regression (e.g., cohort mean average income moves from $30 thousand per year at 25 years old to $45 thousand per year at 35 years old and the $15 thousand increase in income imputed to the user's income growth over those timeframes with monthly income points in the slope between 25 and 35 years old projected through a linear regression of the cohort income data over time). Further, to predict the user's absolute and relative changes to compliance with the user's other financial action plans, a credit card test drive would, for example, employ linear regression like the Markov Chain Monte Carlo method or decision forest regression in order to simulate the ability of the user to maintain income in excess of expenses, and maintain income in at least the amount necessary to pay for expenses that support other financial action plans after deducting the income to pay for fixed expenses necessary for day-to-day support of the user and the user's dependents, such as the cost of housing, food, healthcare, and education.

As a further description of the decision engine 141, to demonstrate test-drive outcome (4), the decision engine 141 would assess the user's financial wellness by performing a weighted assessment of the user's debt to income ratio, income to expenses ratio, average monthly variation in income, average monthly variation in expenses, average monthly variation in income to expenses ratio, credit score, changes to credit score over past year, credit use to credit availability ratio, savings rate, and presence of 3 or 6 months of emergency savings, and provide a numerical score for the user, and reassess the user's financial wellness assuming use of the product or service to provide the user the changes to the user's financial wellness in relative and absolute terms. For example, a credit card test drive may use a numerical computation to calculate the user's financial wellness and determine the absolute and relative changes to user's financial wellness from using the product. In further demonstration of (4) above, the decision engine 141 would predict the user's ability to complete other financial action plans or comply with other user preferences such as cash management preferences or budget preferences. The credit card test drive would, for example, use classification algorithms like multiclass classification algorithms such as a multiclass decision forest or a decision forest regression like fast forest quantile regression to determine characteristics that are statistically significant in success or failure in using the product (including characteristics determined from data at the specific user segment or cohort) or in complying with user's other financial action plans, and then will determine whether user has any of these characteristics through a match analysis, and using numerical computations, will calculate user likelihood of success based on a weighted analysis of the user's matched characteristics.

As a further description of the decision engine 141, to demonstrate test-drive outcome (5), the decision engine 141 would identify alternative products and services to test drive, drawing from the analysis by the product suggestion decision engine 151, and additionally would use prediction algorithms to classify and cluster users in order to demonstrate the percentage difference in satisfaction between the test-driven product and an alternative product among users in the same segment or cohort; demonstrate the percentage difference in financial well-being between users using the test-driven product and users using an alternative product among users in the same segment or cohort; and demonstrate the percentage difference in likelihood of success between users using the test-driven product and users using an alternative product among users in the same segment or cohort. Success in using the product would be defined, for example, by user having annual income greater than annual expenses; lack of penalty interest rates incurred or penalty payments made; reduction in credit score by less than 100 points; and reduction in net wealth by less than 15%. Failure in using the product would be defined, for example, as the failure to satisfy one of the metrics above. For example, in the credit card test drive, the decision engine 141 will use k-nearest neighbors algorithm to classify users for this product, as well as classify characteristics of users in the user's segment or cohort that are statistically significant to successful or unsuccessful use of the product, as well as a K-means clustering algorithm to find collections of features data—or groups—which had not been explicitly associated or labeled, and which can inform the assessment of the user's ability to successfully use a product. The decision engine 141 is not replicable by hand in analog.

Test-drive business rules are defined by the product or service selected for analysis/test drive by the user, including discrete combinations of products, combinations of actions, and combinations of products and actions. Test-drive business rules may depend on whether the user has an existing product in the same product family or an existing service in the same service family (or combination if appropriate). Test-drive business rules also include rules related to the financial wellness, such as levels of user's debt to income ratio, income to expenses ratio, variation in income to expenses ratio, credit score, credit use to credit availability ratio, and savings rate, to assess the user's financial wellness in the test-drive interface. Test-drive business rules may also include financial rules that are generalized rules of thumb or specific to segments or cohorts (such as users ages 20-29 should save at least 7% of income for retirement) and based on the cohort or segment analysis conducted by the decision engine 141 and incorporated into Cohort/Segmentation/Clustering/Classification data 194. As an example embodiment, decision engine 141 assessment of a retirement product test drive as described herein would determine mean average user retirement savings rates for users in specific segments or clusters, and the test-drive business rules would incorporate the mean average savings rate applicable to the user's cluster as a business rule. As a further example, decision engine 141 assessment of a credit card test drive would determine the proportion of monthly credit card payment compared to free-to-spend income, below which users within same segment have a statistically significant decrease in credit card default rates (for example, a monthly credit card payment to free-to-spend income proportion of 45% or less).

As an example embodiment of the test-drive business rules, a car loan, car insurance, and car expenditure bundle that the user selects to test drive for a product fit will have a specific set of business rules associated with the bundle, and the business rules may depend on whether the user has an existing car loan, car insurance, and car expenditures or not. Assuming the user does not have this bundle, the business rules may be based on user data, such as data associated with, extrapolated from, or derived by the user's financial action plan and designated preferences, and also may be based on extrapolated data, such that, for instance, the car loan amount be set to a specific percentage of the user's debt-to-income ratio, the interest rate on the car loan should be set to the average interest rate for similar users for similar loan amounts, that the insurance rate should be set to the average rate for users in the state in which the user lives or accesses the application, and that the expenditures should be set to the average expenditures for users in the state in which the user lives or accesses the application. If the bundle embodies a preapproval API from the auto finance lender or insurer, then the business rules for the bundle will be set to the preapproved amounts and rates.

User-specific product results may comprise the results of the financial assessment that includes a look-back period, a forward projection, or both determined by decision engine 141 as described herein. For example, the impacts or results could be determined on different timeframes, such as on an annual basis, or on a monthly basis or other cadence. The test drive interface shows the user in the user interface 110 the user-specific results, e.g. the impacts or results that the product fit manager 140 determined based on its assessment of the user's specific data. These results may be verbal, visual, text, or some combination of differing presentations.

For instance, in the car bundle described above, the product fit manager 140 draws data from the mobile application server 102, including, but not limited to product data (e.g. product qualities and features data 193), and user data (e.g. user financial or other accounts transactional data 191 such as data regarding user's existing products or actions, user profile data 192 such as data from the user's financial action plan and financial tools) and Cohort/Segmentation/Clustering/Classification data 194. The assessment conducted by the decision engine 141 of the product fit manager 140 would be displayed on the test drive interface as user-specific results, e.g. the impact to the user's financial performance from the bundle across different financial considerations at each point in time of the assessment (e.g., at 1 month, 3 months, 6 months, and 12 months), including, for example, increase in total debt, increase in monthly debt, decrease in monthly available cash, increase in total expenditures for look-back period, increase in monthly expenditures, impact to financial action plan (such as by indicating breach of target spending limits), impact to other financial action plans or user-defined financial goals such as a particular savings goal (such as inability or continued ability to meet defined savings goal), increase in value of total assets, or increase/decrease in net wealth, among other considerations.

User-specific product results may also include other comparisons, such as financial rules of thumb or financial rules associated with the user's cohort or segment, other test drive results obtained by that same user or other users who correlate to the user, such as those within the same cohort or segment as the user, and comparison of the user's status data or financial wellness score to other users in the same cohort or segment as the user. User-specific product results may also include suggestions for further products, actions, or tools, that if used in replacement of or in connection with the test-driven product(s) or service(s), would benefit the user, in each case as described herein. The product fit manager 140 may be configured for presenting a test drive interface for replacement or additional suggested product(s) or service(s), applying test-drive business rules to user data for application in the selected test drive interface for replacement or additional suggested product(s) or service(s), providing user-specific results comprising a financial assessment that includes a look-back period, a forward projection, or both for replacement or additional suggested product(s) or service(s). The user-specific results may include comparison to user-specific results from previously test-driven product(s) or service(s), or user-specific results of alternative combinations of products or actions.

User-specific results may also include an assessment of the user's likelihood of success in using the test-driven product(s) or service(s) as described herein and suggestions for the user to change their historical or projected behavior to ensure that the user would avoid any unwanted costs or consequences from using a given product or service, such as suggestions to reduce the user's expenses in a specific amount or for specific categories; and suggestions to ensure compliance with the user's other financial action plan(s), user budget, or user cash management goals and preferences.

A test drive interface may be presented through the user interface 110. For example, the user interface 110 may display a test drive interface in visual and/or voice format that provides the user the ability to quantitatively verify the proof of value to the user of the product or service that the user may obtain. A test drive interface is presented for each suggested product or service or combination of products and services including cash management or budget preferences as well as financial action plans. The test drive interface may be provided within another portion of the user interface or may be made available for the user to access at any time. The user can select a test drive corresponding to a suggested product or service for which the user would like to ascertain a product fit via a test drive function. For example, a user browsing suggested credit card products on the user interface 101 could select the test drive on a specific credit card. The decision engine 141 calls the business rule(s) which apply to the specific product to build the appropriate test drive assessment. The pseudo steps for building the credit card test drive summary are as follows:

user browses credit card recommendations through the user interface 101
user selects test drive feature for a specific credit card through the user interface 101
user selects timeframe through the user interface 101 to apply the test drive results, or the business rules apply the appropriate timeframes for the product (e.g. credit cards returns 1 month, 3 month, 6 month, and 1 year)
decision engine 141 queries business rules for the specific group identifier, e.g. credit cards
decision engine 141 builds a JavaScript Object Notation (JSON) which includes user-specific results for the look-back and forward-looking timeframe
decision engine 141 sends the JSON response to the user interface 101

Business rules are stored as JSON representations and consist of 4 properties:

name—the name of the specific decision
group—a group identifier to which the rule belongs. A group can have multiple business rules
priority—an integer corresponding to the priority of the rule (lower is higher priority), e.g. 1
conditions—the actual representations of the rules

Conditions are JSON objects which can make use of conditional logic, such as “and” or “or”. Depending upon the rule complexity, the “and” or “or” key could be a JSON array or JSON object. Each unit of a condition is a JSON object consisting of three properties:

key
value—value to be compared, which can be any data type (e.g. string, int, boolean)
comparison operator—a comparison function

The table below shows the comparison operators that are available:

| Comparison Operator | Definition |
|---|---|
| eq(a,b) | Returns true if a strictly equals b. |
| gte(a,b) | Returns true if a is greater than or equal to b |
| gt(a,b) | Returns true if a is greater than b |
| lte(a,b) | Returns true if a is less than or equal to b |
| lt(a,b) | Returns true if a is less than b |
| not(a,b) | Returns true if a is not strictly equal to b |
| div(a,b) | Returns true if a is not divisible by b |

The user interface 110 may permit the user to select multiple products in a product family to simultaneously test drive, to enable a comparison of product fits, e.g. comparison of user-specific results between products. The user interface 110 may permit the user to select products across different product families, e.g. where the products relate to each other, such as car loan and car insurance. The user interface 110 may permit the user to select a product of the same product type as an existing user product to test drive, e.g. via selection of a product or service for test drive, to obtain user-specific results including assessment of the product as a replacement for the user's existing product or as a complementary product to the user's existing product. The user interface 110 may permit the user to select a financial action plan and a product to test drive (e.g. selecting a car bundle financial action plan composed of a car loan, car insurance, car purchase, and a car expenses rule), e.g. via selection of a product or service for test drive, to obtain user-specific results including assessment of product fit with the financial action plan. The user interface 110 may permit the decision engine or the user to tailor the user's financial data, e.g. permitting the user to discount or eliminate nonrecurring or other types of expenses or transactions in the user's historical financial performance so that they do not distort the user's forward projection results.

The test drive interface may demonstrate the user-specific results visually through text or other graphics or verbally; categorically, e.g. results for the user's financial performance in specific categories, such as interest rate, fees, savings, cash, expenses, overall benefits, net wealth, or in any other category; on an aggregate time basis, or for smaller units of time, such as quarterly, or monthly; in relation to the user's historical financial behavior and the user's projected financial behavior and results, including indications for where the user would need to change its behavior to ensure that the user would avoid any costs from using the product or service, such as by reducing the user's expenses in a specific amount or for specific categories or at specific points in time (e.g., reduce certain expenses to avoid expenses exceeding income at month end); in relation to a user designated financial action plan or financial rules of thumb; in relation to test drive results obtained by other users or cohort/segmentation data; or in relation to a comparison of the user's status to other users who correlate to the user, such as a cohort or segment.

The product referral manager 130 is configured to enable the user to acquire a product or service. The product referral manager 130 configurations may include, but are not limited to, applying product-referral business rules to the selected product or service, and referring user to the selected product or service. The product referral manager 130 comprises a decision engine 131 and business rules component 132 that comprises product-referral business rules. The decision engine 131 may also apply product-referral business rules for selected product(s)/service(s) to enable the user to receive any packets or programs, initiate any rewards benefits, or receive any other benefits or information related to the product(s)/service(s).

The product-referral business rules are defined by a given product or service, and may include discrete combinations of related products, combinations of service. The product-referral business rules may depend on whether the user has an existing product in the same product family or partakes in the same service or other service in the same service family (or combination if appropriate). The business rules may also include attaching cookies or other tracking devices to the user device 104 so that it can be ascertained whether the user has taken certain actions outside of the user interface 110, and may also include information provided by or through APIs or other third party product referral engines.

The decision engine 131 applies the product-referral business rules for selected product(s)/service(s) to enable the user to take actions to acquire the product(s)/service(s) through or outside of the user interface 110. The user interface 110 provides users with the ability to enroll in a selected product or service via visual or voice formats including by downloading the product or service provider's application to the user's mobile device. The user interface 110 may provide the user with the ability to obtain a preapproval decision from the provider through an API, website, or other device from the provider. The user interface 110 may provide the user with the ability to request approval from the product or service provider through an API, website, or other device from the provider. The user interface 110 may demonstrate whether the user has been preapproved for the product based on API or website or other real time decisioning by the provider, or the likelihood that the user will be able to obtain the product. The user interface 110 may provide the user with the ability to accept the terms and conditions from a provider through an API or other device from the provider. The user interface 110 may provide the user with the ability to acquire the product through an API, website, downloaded application, or other device from the provider. Once the user acquires a product, the product may be added to the user's profile of products in the user interface 110.

The product referral manager 130 configurations may also include providing product-specific switch kit packets and programs, financial education packets and programs, and product guide packets and programs. For instance, if the product is a credit card, then the product-referral business rules may include providing a preapproval API, an application API, the credit card provider's application, a link to the credit card provider's application, an authentication API or device, an API to read terms and conditions and accept them, the terms and conditions for the product and a request for the user's acceptance of the terms and conditions, among other things. In another example, product referral manager 130 may provide, via the user interface 110, a Switch Kit Packet that includes the steps and descriptions for the actions a user needs to take to replace its existing product. In another example, product referral manager 130 may provide, via the user interface 110, a Product Guide that includes information about the particular product acquired, and a Financial Education Packet that includes financial education about the acquired product. In another example, product referral manager 130 may provide, via the user interface 110, access to information from product or service providers, by providing an application, an API, or any other means of the provider.

The referral fee and rewards manager 160 is configured to obtain a referral fee from providers upon defined trigger events and provide a rewards redemption service in connection with certain actions taken by users, such as downloading of an application or the acquisition of a product. The referral fee and rewards manager 160 configurations may include, but are not limited to, applying referral-fee business rules to the enrolled product or service, allocating a referral fee from a product or service provider to a mobile application provider, applying rewards-redemption business rules to the user's actions with respect to the product or service, and allocating a rewards benefit to the user. The referral fee and rewards manager 160 comprises a decision engine 161 and business rules component 162 that comprises referral-fee business rules and the rewards-redemption business rules, and may be controlled by a third party referral engine or information or requirements provided through or in relation to APIs.

The referral-fee business rules and the rewards-redemption business rules are each defined by product, service, or status. For instance, if the product is credit cards, then the referral-fee business rules may include a specific referral fee for each credit card from a credit card provider when a user successfully applies for a credit card from that provider, and the rewards-redemption business rules may allocate a specific rewards benefit to each credit card from a credit card provider when a user successfully applies for a credit card from that provider.

The decision engine 161 is configured to apply rewards-redemption business rules and display rewards benefit data in the user interface 110 for users, e.g. consumers and small businesses. Rewards benefit data includes, but is not limited to, data regarding rewards obtained through user actions, e.g. referring in a product or service; and data regarding financial counseling, e.g. financial counseling to low and moderate income individuals, or individuals or small businesses located in low and moderate income census tracts. The decision engine 161 displays rewards benefit data in the user interface 110 for each user action that triggers a reward benefit, such as applying for a product, acquiring a product, or referring other users. The decision engine 161 allocates a specific benefit that is associated to each user action that triggers a reward benefit. The user interface 110 may display the user's rewards benefits status, including benefits obtained/provided or status in obtaining a further benefit/reward if the user is in the process of obtaining a benefit/reward.

The decision engine 161 also is configured to apply referral-fee business rules and display referral fee allocation data in the product or service provider/community benefit provider user interface 110. Referral fee allocation data includes, but is not limited to, data regarding referral fees to be allocated to, for example, a mobile application provider or an entity responsible for obtaining enrollment on behalf of the product or service provider or community benefit provider.

The institution systems 103 comprise in part a product or service provider/community benefit provider user interface 110. The product provider or service/community benefit provider user interface 110 may have restricted access; e.g. not accessible until the product or service provider or community benefit provider reaches agreement through a contract or other form of opt in to participate in a program, which provides terms and conditions for participation in the program. If the provider participates in the program, the product or service provider/community benefit provider user interface 110 may cover both product referrals as well as rewards benefits. The referral arrangements will provide for referral fees for work by an entity, such as a mobile application provider, in linking or referring users to products and services. The rewards benefit will provide for a defined benefit (e.g., credit or other financial counseling) to a low-or-moderate income individual, or an individual or small business located in a low-or-moderate income area, consistent with the requirements and standards of the Community Reinvestment Act. The reward benefit will be acquired by the provider, and the referral fee rewards manager 160 will fulfill this award through contracts with community benefit providers.

Account credentials for the product or service provider or community benefit provider may be established to permit restricted access to the product or service provider/community benefit provider user interface 110. These credentials may take any form and they may permit subcredentialing. Through the product or service provider/community benefit provider user interface 110, the provider or community benefit provider may indicate its preferences and requirements for rewards benefit fulfillment that will be incorporated into the business rules component and will govern the fulfillment of the rewards benefits. This designation could be by product type, community benefit provider type, location, among other factors. The product or service provider/community benefit provider user interface 110 may provide a dashboard for the provider and community benefit provider to track the data regarding their referrals and rewards, and enable the provider or community benefit provider to view more detailed data as well as bills, receipts, and other documentation required under the program's terms and conditions.

For each user action that triggers a referral fee, the provider will be charged the fee and may be automatically assessed a rewards benefit fee for the acquisition of a rewards benefit that will be eligible for CRA credit. User actions that trigger a finder's fee and rewards benefit fee will be defined in the terms and conditions with each provider, and the fees associated to each action will be similarly defined. The referral fee process generates a referral fee bill to the provider on a predetermined billing cycle. The rewards fee process generates a rewards benefit fee bill to the provider on a predetermined billing cycle. The first step in the rewards provision process is for the service to automatically issue a fulfillment request to the community benefit provider that matches the provider's designated preferences. The fulfillment request will contain standardized terms, such as request, fulfillment deadline, documentation required for fulfillment, and payment amount. Once the community benefit provider fulfills the request, the community benefit provider returns the required documentation and certifies that the request has been fulfilled pursuant to the terms and conditions of the request and program agreement. The return of the required documentation and certification of fulfillment triggers the designated payment to the community benefit provider. The product or service provider/community benefit provider user interface 110 (and separately the user interface 110 for the user who generated the rewards benefit) will be updated to account for the fulfilled rewards benefit.

The communications manager 165 is configured to enable the user to designate one or more persons to connect to the user's financial action plan and to enable the user and the platform to communicate with those person(s) with respect to the user's financial action plan. The communications manager also is configured to enable users to communicate with each other in designated areas within the user interface 110. The communications manager 165 comprises a decision engine 166 and business rules component 167 that comprises communication business rules. The communication business rules depend on the user designated financial action plan, and the status of the user within the user's designated financial action plan. The communications manager 165 configurations may include, but are not limited to, applying communications business rules to user financial action plans to communicate with the user and the person(s) designated by the user in order to, for instance, prompt the user to take an action or celebrate user's completion of a step in the financial action plan, or to update the user's designees on the user's financial action plan and prompt the user's designees to send the user a message with respect to the user's financial action plan.

The user interface 110 may provide the user the ability to designate person(s) with whom the user wishes to communicate with respect to a financial action plan, or to authorize the service to communicate with, which may include the user consenting to sharing information concerning the user's financial action plan and the status of the user within the financial action plan. The user interface 110 may provide the user and the user's designee(s) to communicate with each other freely or upon being prompted by the service. The user interface 110 may permit the designee to see details and data regarding the user's financial action plan and may permit the user setting permissions for the data that is authorized to share with its designee(s), which permissions become part of the communication business rules for the communications manager 165.

As shown in FIG. 2, in this example system, the mobile application server 102 includes a data intake engine 170, a data normalization layer 180, and a data storage systems 190; all of which may be implemented by hardware, by firmware, by combined hardware and software, or the like. FIG. 2 illustrates the backend of the mobile application server 102 in greater detail.

The data intake engine 170 is configured to intake data, including, but not limited to, receiving user data (e.g. user financial or other accounts and transactional data 171, user generated preferences data 173, user social media profile data 174), receiving product-related data (e.g. products qualities and features data 172, tool data), and receiving community benefit provider data 176. The data intake engine 170 may intake data in numerous ways and from various sources, depending on the type of data. Data with respect to existing products and accounts, including financial accounts and transactional data 171 may be obtained through user-permitted access to existing accounts and products, or from user accounting software, user excel spreadsheets, or another form of user data management. User generated preferences data 173 may be obtained from user through profile settings, user preferences, surveys or other feedback mechanisms; generated from observed user practices; or designation of a user cohort for a user. User generated preferences data 173 may include user tool data, including, but not limited to, data from financial action plan tools, budget tools, cash management tools, and any other user tools; as well as any data related to the establishment or acquisition of those tools and the user's use of those tools. User social media profile data 174 may be obtained through user-permitted access to social media accounts and data from the user's social media accounts. With the user's consent, the user's social media data may be assessed to determine characteristics about the user that could inform the user's preferences.

Products qualities and features data 172 includes, but is not limited to, data regarding price, fees, applicable limits, terms and conditions for use, underwriting standards, status of provider, qualitative reviews, data privacy and data security practices and assessment, and any other information that may be pertinent to a user's decision to obtain a product or service. Products qualities and features data 172 may be obtained from public external data, internal data sources (e.g. internal quality assessments based on user cohort experiences) or external data sources (free or subscription based), consumers, users, providers (directly or indirectly). Community benefit provider data 176 includes, but is not limited to, data regarding community benefit providers that could provide rewards program benefits; e.g. community benefit provider location, length of operation, size, customers, structure, and any other quantitative or qualitative data on a community benefit provider from internal or external databases or sources, public or private, free or subscription based.

The data intake engine 170 is configured to intake other types of data, including, but not limited to, product referral fee and rewards product benefit data 175, customer community benefit provider preferences data 177, community benefit provider rewards provided data 178, and customer rewards generated data 179. Product referral fee and rewards product benefit data 175 includes, but is not limited to, data regarding what the provider would provide in return for referrals, the referrals generated, the amount of referral income generated, as well as data regarding the attributes of the users referred to the provider. Product referral fee and rewards product benefit data 175 also includes, but is not limited to, data regarding the rewards allocation and fee for the rewards program benefit that the referral fee and rewards manager 160 would provide to the provider. Community benefit provider rewards provided data 178 includes, but is not limited to, data regarding the fulfillment of rewards program benefits by community benefit providers; e.g. rewards fulfilled, rewards unfulfilled, success rate, fulfillment time, rewards in progress, total capacity, available capacity, fulfillment of program conditions, and any other quantitative or qualitative measure for how a community benefit provider fulfills rewards program benefits.

While not shown in FIG. 2, the data intake engine 170 may also be configured to intake provider rewards preferences data, product provider rewards generated data, and user UI interaction data. Product provider rewards preferences data includes, but is not limited to, data from product providers regarding their preferences for the generation and fulfillment of a rewards program benefit; e.g. data designating a preferred community benefit provider for the rewards program benefit, a preferred geographic location for the benefit, a preferred type of benefit, and rules or hierarchy that govern the provision of the rewards program benefit, and any quantitative or qualitative data that might be pertinent to the provider. Product provider rewards generated data includes, but is not limited to, data regarding rewards generated for the provider; e.g. rewards generated (by number and value), rewards fulfilled (by number and value), rewards in progress, fulfillment time, fulfillment of program conditions, receipt or other evidence of completion, and any other quantitative or qualitative data regarding the rewards provision. User UI interaction data includes, but is not limited to, data regarding user interaction with the User Interface; e.g. the location of the user, time of use, length of use, actions taken, and any other quantitative or qualitative data about the user interaction with the user interface.

The data normalization layer 180 is configured to clean up and normalize data at any step, including between intake and storage, during storage, between extraction from storage and analysis, when assessed in connection with an assessment mechanism, and after presentation of analysis on a user interface. The data normalization layer 180 comprises a normalization platform 181 and a normalization engine 182 through which the data may be cleaned up and normalized.

The data storage systems 190 is configured to store data originating from the data intake engine 170, including, but not limited to, storing user data (e.g. user financial or other accounts and transactional data 191, user profile data 192), product data (e.g. financial product qualities and features data 193), cohort or segmentation data 194, rewards product benefit data 195, rewards community benefit provider mapping data 196, customer rewards received/obtained data 197, financial product referral fee data 198, community benefit provider rewards provided data (e.g. data regarding the provision of the rewards benefits by community benefit provider), provider rewards generated data (e.g. data regarding the rewards generated by the providers), community benefit provider data, and provider preferences data. Data may be stored in numerous ways, depending on the type of product. User profile data 192 includes, but is not limited to, a user's credentials, user-generated preferences, server-generated user preferences, user social media data and preferences ascertained from that data, user cohort or segment, and data related to user selected tools (e.g. financial action plan tool, budget tool, or cash management tool). Cohort or segmentation data 194 includes, but is not limited to, data stored by defined cohort or segment, e.g. products used, products obtained, user tools, and any other data that corresponds to a defined cohort or segment. A user may get segmented or attributed to a defined cohort on the basis of the user's survey results.

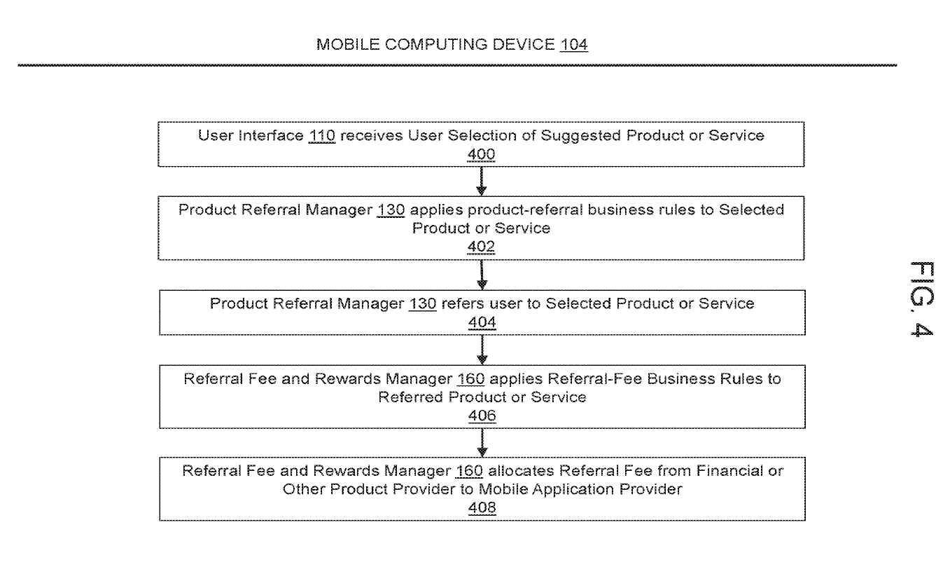

FIG. 3 is a flow chart of an exemplary method for providing user-specific results comprising a financial assessment that includes a look-back period, a forward projection, or both according to embodiments of the present disclosure. In this example, reference is made to the mobile computing device 104 shown in FIG. 1 for purposes of illustration; however reference to the mobile computing device 104 should not be construed as limiting, and it should be appreciated that the method may be implemented by any suitable computing device comprising a processor and memory.

Referring to FIG. 3, the method includes the Data Intake Engine 170 receiving User Financial or Other Accounts Transactional Data 171 from Institution Systems 103 (step 200), the Data Storage Systems 190 storing User Accounts and Transactional Data 191 (step 202), and the Test-drive Subsystem 115 receiving and storing User Financial or Other Accounts and Transactional Data 191 from Institution Systems 103 (step 300); the Data Intake Engine 170 receiving Financial or Other Product Qualities and Features Data 172 from I/O 105 or Mobile Application Server 102 or Institution Systems 103 (step 210), the Data Storage Systems 190 storing Financial or Other Products Qualities and Financial Data 193 (step 212), and the Test-drive Subsystem 115 receiving and storing Financial or Other Products Qualities and Features Data 193 from I/O 105 or Mobile Application Server 102 or Institution Systems 103 (step 302); the Data Intake Engine 170 receiving User Generated Preferences and Behavior Data 173 and User Social Media Data 174 from User Interface 110, I/O 105 or Mobile Application Server 102 or Institution Systems 103 (step 220), the Data Storage Systems 190 storing User Profile Data 192 and Cohort/Segmentation/Clustering/Classification Data 194 (step 224), and the Test-drive Subsystem 115 receiving and storing User Profile Data 192 and Cohort/Segmentation/Clustering/Classification Data 194 from User Interface 110, I/O 105 or Mobile Application Server 102 (step 304); the User Interface 110 receiving User Selection of Financial Action Plan or Product Type(s) or Action Type(s) (step 306); the Product Suggestion Manager 150 applying Product-Suggestion Business Rules to User Financial Data (step 308); the Product Suggestion Manager 150 determining Suggested Product(s) or Action(s) (step 310); the User Interface 110 presenting Test Drive Interface for Suggested Each Product or Action (step 312); the User Interface 110 receiving User Selection of Test Drive Interface (step 314); the Product Fit Manager 140 applying Product-Fit Business Rules to Data (Step 316); the Product Fit Manager 140 providing User-Specific Product Results via User Interface 110 (step 318); and the User Interface 110 receiving User Selection of Product or Action to Test Drive (step 320).

As used herein, “test-drive subsystem” refers to the structures to obtain data from data storage systems 190 in order to permit user to assess a product for its fitness for purpose by demonstrating to the user quantitatively and qualitatively whether the product would meet the user's needs without creating any negative or unintended consequences to the user and enabling the user to specifically compare multiple products in the same product family.

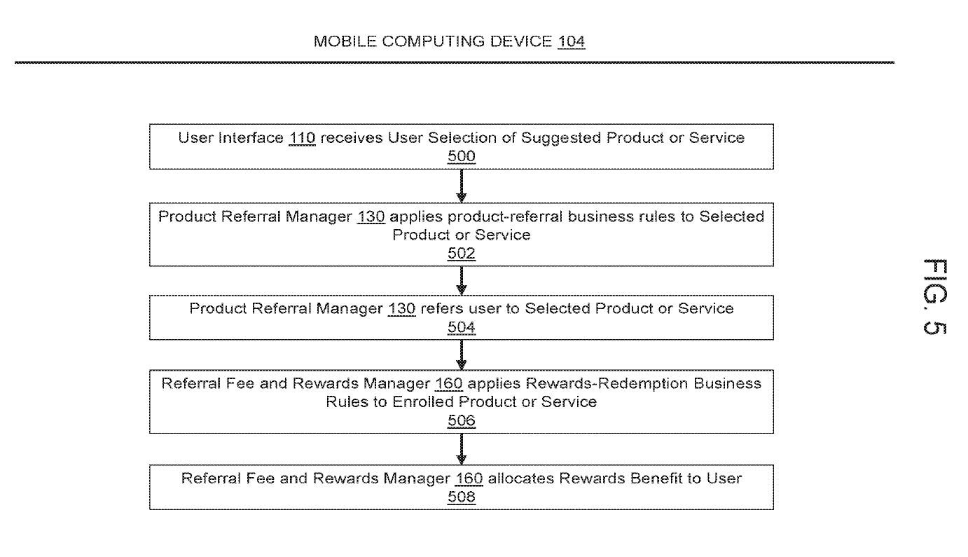

FIG. 4 is a flow chart of an exemplary method for referring a user to selected product or service, and allocating a referral fee to mobile application provider according to embodiments of the present disclosure. In this example, reference is made to the user device 104 shown in FIG. 1 for purposes of illustration; however reference to the mobile computing device 104 should not be construed as limiting, and it should be appreciated that the method may be implemented by any suitable computing device comprising a processor and memory.

Referring to FIG. 4, the method adds steps to the flow chart depicted in FIG. 3 and includes receiving user selection of one suggested product or service (step 400), applying product-referral business rules to the selected product or service (step 402), referring user to the selected product or service (step 404), applying referral-fee business rules to the enrolled product or service (step 406), and allocating a referral fee from the provider to a mobile application provider (step 408).

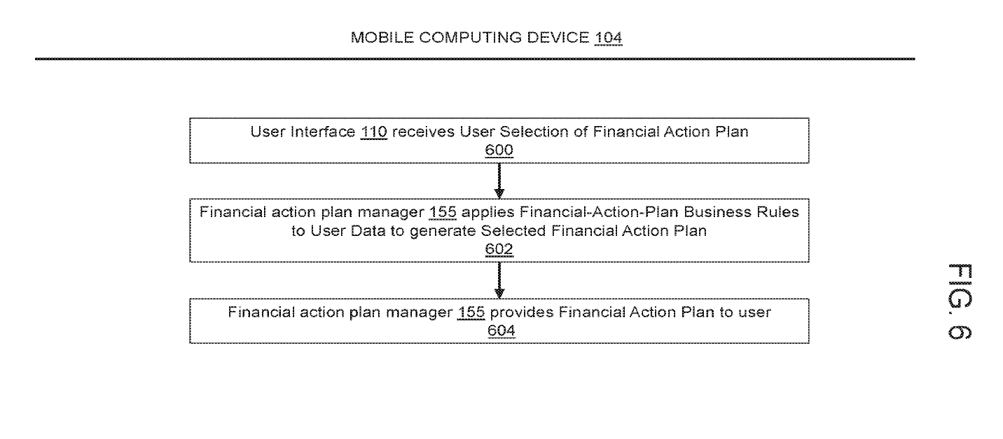

FIG. 5 is a flow chart of an exemplary method for referring a user to selected product or service, and allocating a rewards benefit to user according to embodiments of the present disclosure. In this example, reference is made to the mobile computing device 104 shown in FIG. 1 for purposes of illustration; however reference to the mobile computing device 104 should not be construed as limiting, and it should be appreciated that the method may be implemented by any suitable computing device comprising a processor and memory.

Referring to FIG. 5, the method adds steps to the flow chart depicted in FIG. 3 and includes receiving user selection of one suggested product or service (step 500), applying product-referral business rules to the selected product or service (step 502), referring user to the selected product or service (step 504), applying rewards-redemption business rules to the enrolled product or service (step 506), and allocating a rewards benefit to user (step 508).

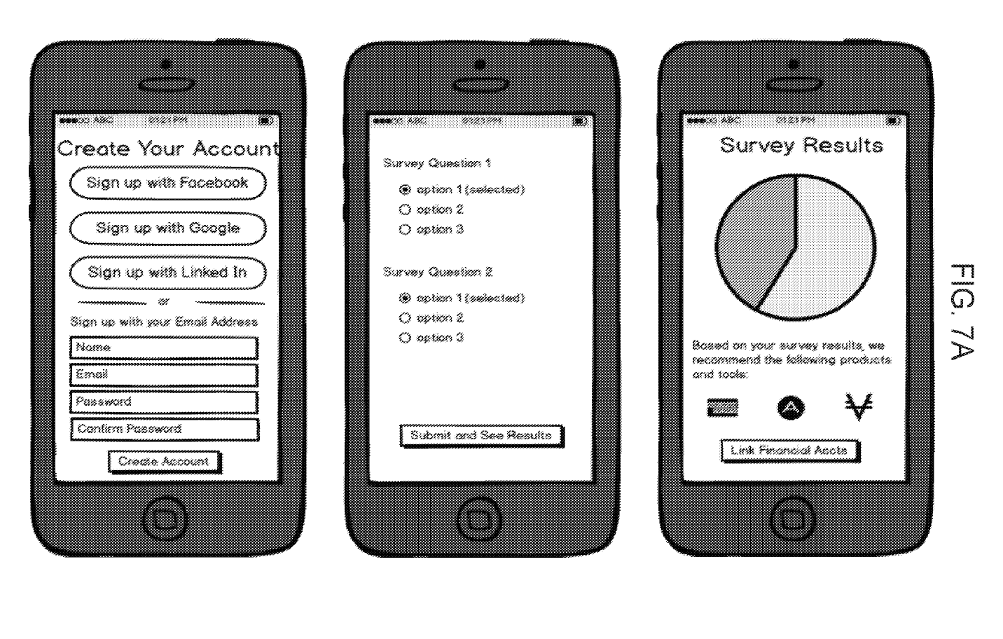

FIG. 6 is a flow chart of an exemplary method for providing financial action plan data according to embodiments of the present disclosure. The method adds steps to the flow chart depicted in FIG. 3 and includes receiving a user designated financial action plan (step 600), applying financial-action-plan business rules to user data (step 602), and providing financial action plan data (step 604). In this example, reference is made to the mobile computing device 104 shown in FIG. 1 for purposes of illustration; however reference to the mobile computing device 104 should not be construed as limiting, and it should be appreciated that the method may be implemented by any suitable computing device comprising a processor and memory.

Home Purchase Example of Test-Drive Platform.

For example, consider a user that has a monthly rental obligation who has determined that s/he would like to understand the product fit of a home purchase

1) Mobile application server 102 would obtain and store:
a. product data—user connects mobile application server 102 to user's financial or other products data and mobile application server 102 obtains user's financial or other products data
b. user financial performance data—data that is assessed and classified out of user's product data
c. cash management preferences—user designates cash management preferences through user interface 110
d. profile data—mobile application server 102 captures user profile data and data regarding user actions and behaviors on the user interface 110 as well as data provisioned by user through the mobile application server 102, such as social media data 174
e. financial action plans—in the user interface 110 user initiates home purchase financial action plan and other financial action plans through financial action plan manager 155
f. financial products data—manually inputted or downloaded data sets from public and private data set providers impacting a home purchase financial decision such as mortgage products data, insurance products data, closing services data, realtor data, title search services data, school district data, home prices data, and home utilities services
g. cohort/segmentation/clustering/classification data—data resulting from the assessment of data in 1.a.-1.e. for user and other users through prediction and clustering algorithms
   2) Relevant data encompassed in 1.a.-1.f. is brought into test-drive subsystem 115 to enable the test drive interaction application 120
a. 1.a. data relevant to the test-drive includes all user debt products and user financial accounts holding user assets
b. 1.b. data relevant to the test-drive includes monthly data comparing user's income and expenses and the amount of monthly rent payments and home utilities services
c. 1.c. data relevant to the test-drive includes user's designation of the percent or amount of user's income the user would like to allocate to fixed expenses, to savings goals and other financial action plans, and to be freely able to spend
d. 1.d. data relevant to the test-drive includes data concerning user's preferences within its profile data, such as preference for bank products over nonbank products
e. 1.e. data relevant to the test drive includes the home purchase financial action plan and other financial action plans through financial action plan manager.
f. 1.f. data relevant to the test-drive includes mortgage products data, insurance products data, closing services data, realtor data, title search services data, school district data, home prices data (including forward projections), home utilities services, inflation data (including forward projections), interest rate data (including forward projections), and cost of living data (including forward projections)
g. 1.g. data relevant to the test-drive includes data classifying home financial products, data on user segments or cohorts or data on user or behavioral or feature clusters.
   3) Product Suggestion Manager 150 will use prediction and clustering algorithms to assess this data and display suggested products or services
   4) User will select product to test drive through the test drive interface
   5) Product Fit Manager 140 will conduct analysis on the following to ascertain and demonstrate product fit to user through user interface 110:
a. data regarding whether and how the user's historical financial behaviors and outcomes would be affected as if the user had been using the product
b. data regarding whether and how the user's historical behaviors and practices would be consistent with good usage of the product or would result in issues in using the product such as by incurring additional or penalty costs
c. data regarding whether and how the user can expect to be impacted by using the product through forward projections that would show the extent to which using the product would impact the user's cash management preferences, budget goals, or other financial action plans
d. data regarding whether the user is likely to succeed in using the product based on a behavioral assessment of user in relation to the product characteristics and other user experience with the product and in relation to the user's cash management preferences, budget goals, or other financial action plans
e. data regarding any alternatives to the selected product that may improve outcomes for the user relative to the test driven product
   6) Decision engine 141 would integrate business rules from business rules component 142 to conduct the appropriate test-drive for the user—e.g., a comparison of a home mortgage product for a home purchase in the user's designated geography for a user who has a monthly rental payment that would be replaced by the mortgage payment
   7) Decision engine 141 would assess step 5.a. by:
a. Comparing the user's monthly mortgage payment in relation to the user's monthly rental payment and applying that difference to the user's monthly fixed expenses and adding the total debt amount to user's total debt amount
b. Calculating the home asset value and changes in asset value and apply those values to the user's assets; based on the specific change in home value for a specific home designated by the user or if none, the average change in home value in the user's designated geography
c. Calculating the change in user's net wealth resulting from adding the total mortgage debt and home asset values to user's existing total debt and asset values
   8) Analysis in step 5.a. would be demonstrated through the user interface 110 by:
a. Displaying the user's absolute and relative changes in expenses across the user's historical timeframes (e.g., 1 month, 3 months, 6 months, 1 year)
b. Displaying the user's absolute and relative changes in income across the user's historical timeframes (e.g., 1 month, 3 months, 6 months, 1 year)—in this example, there would be no changes
c. Displaying the user's absolute and relative changes in debt across the user's historical timeframes (e.g., 1 month, 3 months, 6 months, 1 year)
d. Displaying the user's absolute and relative changes in assets across the user's historical timeframes (e.g., 1 month, 3 months, 6 months, 1 year)
e. Displaying the absolute and relative changes in net wealth for the user across the user's historical timeframes (e.g., 1 month, 3 months, 6 months, 1 year)
   9) Decision engine 141 would assess step 5.b. by:
a. Determining the historical months in which the user would face difficulty in or failure to meet expenses if the user were using the product by employing a numerical calculation method to calculate the mean variation of user's expenses to income ratio and determine whether the new product increases expenses or decrease income in any month by an amount in excess of the mean variation (considered a “difficulty month”), as well as determine whether the new product or service increases expenses or decrease income in any month to such an extent that the user's expenses are greater than income (considered a “failure month”).
b. Determining the frequency of difficult or failure months compared to the entire time series (by 1, 3, 6, 9, 12, 24, 36, 48, 72 months) by employing a numerical calculation method to calculate the aggregate data on the frequency of difficult or failure months compared to the entire user historical time series (by 1, 3, 6, 9, 12, 24, 36, 48, 72 months) to demonstrate severity to the user on a proportional basis (e.g., user would experience difficulty for 2 out of 6 months and failure for 1 out of 6 months, in the aggregate user would be unsuccessful in using product for 50% of the time).
c. Determining user historical behaviors that support or detract from successful use of the product by employing category prediction algorithms, like Bayesian parameter averaging, and/or multinomial logistic regression, to define classes or clusters of users that the user belongs to, and then finding characteristics in the class that are statistically significant in predicting success or failure in using the product, and then identifying whether the user has those characteristic(s).
   10) Analysis in step 5.b. would be demonstrated through the user interface 110 by:
a. Highlighting months in which the user would face difficulty or fail to be able to cover the user's historical expenses.
b. Providing user aggregate data on the frequency of difficult or failure months compared to the entire time series (e.g. 3 out of 6 months, or ½ of the assessed period)
c. Notifying the user of the user's historical behaviors that support or detract from successful usage of the product (e.g., savings rate of less than 2% of income)
   11) Decision engine 141 would assess step 5.c. by:
a. Predicting the user's absolute and relative changes in expenses, income, debt, assets, and net worth across a forward-looking timeframe, by employing numerical calculations such as an iterative method to add the impact of the product on those categories going forward, and by employing, for example, a linear regression, such as the Markov Chain Monte Carlo method, to simulate changes in interest rates as well as user expenses and income, and add these simulations to the iterative method described above.
b. Comparing to the assessment of the user's historical transactions described in 5.b., above using a simple numerical comparison of categorical outputs based on timeframe (e.g., 1, 3, 6, 9, 12 months), and identifying drivers for the differential through a regression analysis.
c. Predicting the growth in user's income and expenses by employing classification algorithms like multiclass classification algorithms such as a multiclass decision forest to identify segments and cohorts for the user, and calculating the mean average expenses and income by age parameters, in order to project the user's expenses and income at future points, with slope points being determined through linear regression (e.g., cohort mean average income moves from $30 thousand per year at 25 years old to $45 thousand per year at 35 years old and the $15 thousand increase in income imputed to the user's income growth over those timeframes with monthly income points in the slope between 25 and 35 years old projected through a linear regression).
d. Predicting the user's absolute and relative changes to compliance with the user's cash management or budgeting preferences and other financial action plans by employing linear regression like the Markov Chain Monte Carlo method or decision forest regression in order to ascertain the ability of the user to maintain income in excess of expenses, as well as the ability to maintain income in at least the amount necessary to pay for expenses that support other financial action plans after deducting the income to pay for fixed expenses necessary for day-to-day support of the user and the user's dependents, such as the cost of housing, food, healthcare, and education.
   12) Analysis 5.c. would be demonstrated through the user interface 110 by:
a. Displaying the user's absolute and relative changes in expenses across forward looking timeframes (e.g., 1 month, 3 months, 6 months, 1 year, and multiples of 1 year) and in comparison to the user's historical assessment in 5.b. and identifying the key drivers for the differences with the assessment in 5.b.
b. Displaying the absolute and relative changes in assets and net wealth for the user across the user's historical timeframes (e.g., 1 month, 3 months, 6 months, 1 year) and in comparison to the user's historical assessment in 5.b. and identifying the key drivers for the differences with the assessment in 5.b.
c. Displaying the user's absolute and relative changes in meeting the user's cash management or budgeting preferences
d. Displaying the absolute and relative changes in the user's ability to complete other financial action plans or comply with other user preferences
   13) Decision engine 141 would assess step 5.d. by:
a. Assessing the user's financial wellness by performing a weighted assessment of the user's debt to income ratio, income to expenses ratio, average monthly variation in income, average monthly variation in expenses, average monthly variation in income to expenses ratio, credit score, changes to credit score over past year, credit use to credit availability ratio, savings rate, and presence of 3 or 6 months of emergency savings, and provide a numerical score for the user, and reassess the user's financial wellness assuming use of the product or service to provide the user the changes to the user's financial wellness in relative and absolute terms by using a numerical computation to calculate the user's financial wellness and determine the absolute and relative changes to user's financial wellness from using the product.
b. Predicting the user's ability to successfully use the product, or to complete other financial action plans or comply with other user preferences such as cash management preferences or budget preferences, by using classification algorithms like multiclass classification algorithms such as a multiclass decision forest or a decision forest regression like fast forest quantile regression, to determine characteristics that are statistically significant in success or failure in using the product (including characteristics determined from data at the specific user segment or cohort) or in complying with user's other financial action plans, and then determining whether user has any of these characteristics through a match analysis, and using numerical computations, will calculate user likelihood of success based on a weighted analysis of the user's matched characteristics.
   14) Analysis in 5.d. would be demonstrated through the user interface 110 by:
a. Providing the impact on the user's financial wellness in relative and absolute terms (e.g., reduction in cash from downpayment results in less than 3 months of emergency savings and decreases ability to cope with financial stress thereby decreasing financial wellness by 15 points to a wellness score of 70 out of 100)
b. Providing the user a percentage of likelihood of success in using the product
c. Showing the user the factors that are predictive of successful or unsuccessful use of a home mortgage product
d. Showing the user what changes could be made to the user's behaviors to increase the likelihood of success, such as diverting excess payments from student loans to regenerating 3 months of emergency savings
e. Demonstrating how those changes would impact the user's financial health in relative and absolute terms
f. Demonstrating how those changes would impact the user's percentage of likelihood in success in using the product in relative and absolute terms
g. Demonstrating in absolute and relative terms how those changes would impact the user's ability to complete other financial action plans or comply with other user preferences
   15) Decision engine 141 would assess step 5.e. by:
a. Drawing from the analysis by the product suggestion decision engine 151 to identify alternative products.
b. Demonstrating the percentage difference in satisfaction between the test-driven product and an alternative product among users in the same segment or cohort by using prediction algorithms to classify and cluster users according to product use by using k-nearest neighbors algorithm.
c. Demonstrate the percentage difference in financial well-being between users using the test-driven product and users using an alternative product among users in the same segment or cohort by calculating the mean average for the financial well-being score for the cluster of users using the test-driven product as well as the well-being score for the cluster of users using the alternative product, and comparing to the financial well-being score of the user.
d. Demonstrate the percentage difference in likelihood of success, such as having annual income greater than annual expenses; lack of penalty interest rates incurred or penalty payments made; reduction in credit score by less than 100 points; and reduction in net wealth by less than 15%, between users using the test-driven product and users using an alternative product among users in the same segment or cohort, by using k-nearest neighbors algorithm to classify users for this product, as well as classify characteristics of users in the user's segment or cohort that are statistically significant to successful or unsuccessful use of the product, as well as a K-means clustering algorithm to find collections of features data—or groups—which had not been explicitly associated or labeled, and which can inform the assessment of the user's ability to successfully use a product.
   16) Analysis in 5.e. would be demonstrated through the user interface 110 by:
a. Displaying the alternative products and demonstrating the relative differences between the alternative product and the test-driven product, such as:
   i. the percentage difference in satisfaction with these products among users in the same cohort as the users;
   ii. the percentage difference in user financial well-being between users using the alternative product and users using the test-driven product;
   iii. and the percentage difference in user's likelihood of success in using the product.

The various techniques described herein may be implemented with hardware or software or, where appropriate, with a combination of both. For example, the mobile computing device 104 shown in FIG. 1 may include suitable hardware, software, or combinations thereof configured to implement the various techniques described herein. The methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1-10. (canceled)

11. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service:
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: determining historical months in which the user would have faced difficulty or failure in meeting expenses if the user were using the user selected product(s) or service(s), wherein the computer-executable program instructions of the product fit manager comprises computer-executable program instructions to employ numerical computations to:
calculate a mean variation of user's expenses to income ratio,
determine a difficulty month wherein the user selected product(s) or service(s) increases expenses or decreases income in any month by an amount in excess of the mean variation, and
determine a failure month wherein the user selected product(s) or service(s) increases expenses or decreases income in any month to such an extent that the user's expenses are greater than income; and
providing, by a product fit manager of the mobile computing device, user-specific results comprising a financial assessment that includes a look-back period comprising data regarding whether and how user historical behaviors and practices would be consistent with good usage of the user selected product(s) or service(s) or would result in issues in using the user selected product(s) or service(s), a forward projection, or both a look-back period and a forward projection;
wherein the step of providing user-specific results comprises: displaying historical months in which the user would have faced difficulty or failure in meeting expenses if the user were using the user selected product(s) or service(s); and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

12. A method to test-drive a product or service and provide user-specific results via a test-drive interactive component, comprising:
at a mobile computing device comprising a processor and memory:
receiving and storing, in a test-drive subsystem of the mobile computing device, user data;
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: determining frequency of difficulty month(s) or failure month(s) compared to a user historical time series, wherein the computer-executable program instructions of the product fit manager comprises computer-executable program instructions to employ numerical computations to:
calculate aggregate data on the frequency of difficulty month(s) or failure month(s) compared to the user historical time series to demonstrate severity on a proportional basis; and
providing, by a product fit manager of the mobile computing device, user-specific results comprising a financial assessment that includes a look-back period comprising data regarding whether and how user historical behaviors and practices would be consistent with good usage of the user selected product(s) or service(s) or would result in issues in using the user selected product(s) or service(s), a forward projection, or both a look-back period and a forward projection;
wherein the step of providing user-specific results comprises: displaying frequency of difficulty month(s) or failure month(s) compared to a user historical time series; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

13. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service:
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: determining user historical behaviors that support or detract from successful use of the user selected product(s) or service(s), wherein the computer-executable program instructions of the product fit manager comprises computer-executable program instructions to employ clustering algorithms to:
define classes or clusters of users that the user belongs to,
find characteristics in the class that are statistically significant in predicting success or failure in using the user selected product(s) or service(s), and
identify whether the user has the characteristics; and
providing, by a product fit manager of the mobile computing device, user-specific results comprising a financial assessment that includes a look-back period comprising data regarding whether and how user historical behaviors and practices would be consistent with good usage of the user selected product(s) or service(s) or would result in issues in using the user selected product(s) or service(s), a forward projection, or both a look-back period and a forward projection;
wherein the step of providing user-specific results comprises: displaying user historical behaviors that support or detract from successful use of the user selected product(s) or service(s); and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

14. The method of claim 13, wherein the clustering algorithms to predict categories comprises Bayesian parameter averaging or multinomial logistic regression.

15. (canceled)

16. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: predicting the user's absolute and relative changes to compliance with the user's cash management or budgeting preferences and other financial action plans; and
providing, by a product fit manager of the mobile computing device, user-specific results comprising a financial assessment that includes a look-back period; a forward projection comprising data regarding whether and how the user can expect to be impacted by using the user selected product(s) or service(s) and the extent to which using the product would impact the user's cash management preferences, budget goals, or other financial action plans; or both a look-back period and a forward projection;
wherein the step of providing user-specific results comprises: displaying the user's absolute and relative changes to compliance with the user's cash management or budgeting preferences and other financial action plans; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

17. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: predicting the user's absolute and relative changes in meeting the user's cash management or budgeting preferences; and
providing, by a product fit manager of the mobile computing device, user-specific results comprising a financial assessment that includes a look-back period; a forward projection comprising data regarding whether and how the user can expect to be impacted by using the user selected product(s) or service(s) and the extent to which using the product would impact the user's cash management preferences, budget goals, or other financial action plans; or both a look-back period and a forward projection;
wherein the step of providing user-specific results comprises: displaying the user's absolute and relative changes in meeting the user's cash management or budgeting preferences; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

18. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises: predicting the absolute and relative changes in the user's ability to complete other financial action plans or comply with other user preferences; and
providing, by a product fit manager of the mobile computing device, user-specific results comprising a financial assessment that includes a look-back period; a forward projection comprising data regarding whether and how the user can expect to be impacted by using the user selected product(s) or service(s) and the extent to which using the product would impact the user's cash management preferences, budget goals, or other financial action plans; or both a look-back period and a forward projection;
wherein the step of providing user-specific results comprises: displaying the absolute and relative changes in the user's ability to complete other financial action plans or comply with other user preferences; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

19. A method to test-drive a product or service and provide user-specific results via a test-drive interactive component, comprising:
at a mobile computing device comprising a processor and memory:
receiving and storing, in a test-drive subsystem of the mobile computing device, user data;
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises:
assessing the user's financial wellness, wherein the computer-executable program instructions of the product fit manager comprises computer-executable program instructions to: perform a weighted assessment of the user's debt to income ratio, income to expenses ratio, average monthly variation in income, average monthly variation in expenses, average monthly variation in income to expenses ratio, credit score, changes to credit score over past year, credit use to credit availability ratio, savings rate, and presence of 3 or 6 months of emergency savings; and
reassessing the user's financial wellness assuming use of the selected product(s) or service(s), wherein the computer-executable program instructions of the product fit manager comprises computer-executable program instructions to: employ numerical computations to calculate the user's financial wellness and determine the absolute and relative changes to user's financial wellness from using the selected product(s) or service(s); and
providing, by a product fit manager of the mobile computing device, user-specific results comprising a financial assessment that includes a look-back period; a forward projection comprising data regarding whether the user is likely to succeed in using the selected product(s) or service(s) based on a behavioral assessment of user in relation to the selected product(s) or service(s) characteristics and other user experience with the selected product(s) or service(s); or both a look-back period and a forward projection;
wherein the step of providing user-specific results comprises: providing a numerical score for user financial wellness; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

20. A method to test-drive a product or service and provide user-specific results via a test-drive interactive component, comprising:
at a mobile computing device comprising a processor and memory:
receiving and storing, in a test-drive subsystem of the mobile computing device, user data:
receiving and storing, in the test-drive subsystem of the mobile computing device, product data from a provider, wherein such product data relates to a product or service:
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises:
predicting the user's ability to successfully use the selected product(s) or service(s), wherein the computer-executable program instructions of the product fit manager comprises computer-executable program instructions to: determine characteristics that are statistically significant in success or failure in using the selected product(s) or service(s); and
determining whether the user has any of the statistically significant characteristics, and calculating user likelihood of success, wherein the computer-executable program instructions of the product fit manager comprises computer-executable program instructions to: perform a match analysis based on a weighted analysis of the user's matched characteristics; and
providing, by a product fit manager of the mobile computing device, user-specific results comprising a financial assessment that includes a look-back period; a forward projection comprising data regarding whether the user is likely to succeed in using the selected product(s) or service(s) based on a behavioral assessment of user in relation to the selected product(s) or service(s) characteristics and other user experience with the selected product(s) or service(s); or both a look-back period and a forward projection;
wherein the step of providing user-specific results comprises:
displaying absolute and relative changes to user's financial wellness from using the selected product(s) or service(s); and
displaying user likelihood of success in using the selected product(s) or service(s); and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

21. A method to test-drive a product or service and provide user-specific results via a test-drive interactive component, comprising:
at a mobile computing device comprising a processor and memory:
receiving and storing, in a test-drive subsystem of the mobile computing device, user data;
receiving and storing, in the test-drive subsystem of the mobile computing device, product data from a provider, wherein such product data relates to a product or service:
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises:
identifying alternative product(s) or service(s) from the product-suggestion manager, and
assessing a percentage difference in satisfaction between the test-driven product(s) or service(s) and an alternative product(s) or service(s) among users in the same user segment or cohort; and
providing, by a product fit manager of the mobile computing device, user-specific results comprising a financial assessment that includes a look-back period, a forward projection comprising data regarding whether and how any alternatives to the selected product(s) or service(s) that would improve outcomes for the user relative to the test driven product(s) or service(s), or both a look-back period and a forward projection;
wherein the step of providing user-specific results comprises:
displaying the percentage difference in satisfaction between the test-driven product(s) or service(s) and an alternative product(s) or service(s) among users in the same user segment or cohort; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

22. A method to test-drive a product or service and provide user-specific results via a test-drive interactive component, comprising:
at a mobile computing device comprising a processor and memory:
receiving and storing, in a test-drive subsystem of the mobile computing device, user data;
receiving and storing, in the test-drive subsystem of the mobile computing device, product data from a provider, wherein such product data relates to a product or service;
receiving, by a user interface of the mobile computing device, user selection of at least one of a product type, or a service type;
applying, by a product suggestion manager of the mobile computing device, product-suggestion business rules to user data;
determining, by the product suggestion manager of the mobile computing device, at least one suggested product or service based on the applied product-suggestion business rules;
presenting, by the user interface of the mobile computing device, a test drive interface for the suggested product(s) or service(s);
receiving, by the user interface of the mobile computing device, user selection of at least one of the suggested product(s) or service(s) for test drive;
applying, by a product fit manager of the mobile computing device, test-drive business rules to user data for application in the test drive interface for the user selected product(s) or service(s);
wherein the step of applying test-drive business rules comprises:
identifying alternative product(s) or service(s) from the product-suggestion manager; and
calculating the percentage difference in financial well-being between users using the test-driven product(s) or service(s) and using alternative product(s) or service(s) among users in the same segment or cohort, wherein the computer-executable program instructions of the product fit manager comprises computer-executable program instructions to:
calculate the mean average for the financial well-being score for the cluster of users using the test-driven product and the well-being score for the cluster of users using the alternative product, and comparing to the financial well-being score of the user; and
calculate the percentage difference in success metrics; and
providing, by a product fit manager of the mobile computing device, user-specific results comprising a financial assessment that includes a look-back period, a forward projection comprising data regarding whether and how any alternatives to the selected product(s) or service(s) that would improve outcomes for the user relative to the test driven product(s) or service(s), or both a look-back period and a forward projection;
wherein the step of providing user-specific results comprises: displaying the percentage difference in financial well-being between users using the test-driven product(s) or service(s) and using alternative product(s) or service(s) among users in the same segment or cohort; and
wherein the product fit manager of the mobile computing device comprises computer-executable program instructions to employ numerical computations not replicable by hand in analog, regression analysis, multi-class classification algorithms, or clustering algorithms, prediction algorithms, decision trees, random forests, and gradient boosts.

23. (canceled)
